(19) United States
(12) Patent Application Publication
(10) Pub. No.: US 2022/0005140 A1
(43) Pub. Date: Jan. 6, 2022

(54) METHOD, APPARATUS, AND SYSTEM FOR PROVIDING A CONTEXTUALLY RELEVANT VEHICLE COMPARISON

(71) Applicant: HERE Global B.V., Eindhoven (NL)

(72) Inventors: Jerome BEAUREPAIRE, Berlin (DE); Jens VON LINDEQUIST, Birkenderder (DE)

(21) Appl. No.: 17/117,949

(22) Filed: Dec. 10, 2020

Related U.S. Application Data
(60) Provisional application No. 63/048,493, filed on Jul. 6, 2020.

(51) Int. Cl. G06Q 50/30; G06N 5/04; G07C 5/08; G06Q 10/06; G06Q 30/00; G06Q 50/26; G06Q 30/02; G06Q 30/06; G06F 16/9535

(52) U.S. Cl. CPC G06Q 50/30; G06N 5/04; G07C 5/0841; G06Q 10/06315; B60W 60/00253; G06Q 50/26; G06Q 30/0284; G06Q 30/0631; G06F 16/9535; G06Q 30/018

(57) ABSTRACT

An approach is disclosed for providing a contextually relevant vehicle comparison for a given trip. The approach involves, for example, determining contextual data associated with a trip request, a plurality of candidate vehicles available to complete the trip, a plurality of candidate modes of vehicle operation available to complete the trip request, or a combination thereof. The approach also involves processing the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request. The approach further involves selecting a recommended vehicle, a recommended mode of vehicle operation, or a combination thereof based on the respective energy-efficiency scores. The approach further involves providing data for presenting the recommended vehicle, the recommended mode of vehicle operation, or a combination thereof.

### RELATED APPLICATION

This application claims priority from U.S. Provisional Application Ser. No. 63/048,493, entitled “METHOD, APPARATUS, AND SYSTEM FOR PROVIDING A CONTEXTUALLY RELEVANT VEHICLE COMPARISON,” filed on Jul. 6, 2020, the contents of which are hereby incorporated herein in their entirety by this reference.

### BACKGROUND

Location-based service providers (e.g., mapping and navigation providers) are continually challenged to provide compelling services and applications. One area of development relates to providing navigation guidance and/or other mapping-related information via various means or modes of transportation (e.g., private transportation, public transportation, shared vehicles, walking, etc.). While many users may prefer private modes of transportation (e.g., based on familiarity, convenience, etc.), there is also a growing trend towards more energy efficient vehicle usage (e.g., to reduce environmental impact, pollution, vehicle ownership costs, etc.). Consequently, vehicle sharing or mobility services (e.g., shared cars, shared bicycles, shared scooters, shared rollers, etc.) are increasingly becoming a popular alternative to both private and public modes of transportation, for example, due to the advantages that they can provide in terms of energy efficiency (e.g., carpooling, less vehicles on the roads, etc.) and convenience (e.g., flexibility with respect to when and where vehicles can be picked up and dropped off, etc.). However, as the overall number of options and complexity of corresponding attributes and variables increases, service providers face significant technical challenges to convey all the various options in a way that is contextually relevant and easily understood.

### Some Example Embodiments

Therefore, there is a need for an approach for providing a contextually relevant vehicle comparison for a given trip.

According to one embodiment, a method comprises determining contextual data associated with a trip request, a plurality of candidate vehicles available to complete the trip request, a plurality of candidate modes of vehicle operation available to complete the trip request, or a combination thereof. The method also comprises processing the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request. The method further comprises selecting a recommended vehicle, a recommended mode of vehicle operation, or a combination thereof based on the respective energy-efficiency scores. The method further comprises providing data for presenting the recommended vehicle, the recommended mode of vehicle operation, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine contextual data associated with a trip request, a plurality of candidate vehicles available to complete the trip request, a plurality of candidate modes of vehicle operation available to complete the trip request, or a combination thereof. The apparatus is also caused to process the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request. The apparatus is further caused to select a recommended vehicle, a recommended mode of vehicle operation, or a combination thereof based on the respective energy-efficiency scores. The apparatus is further caused to provide data for presenting the recommended vehicle, the recommended mode of vehicle operation, or a combination thereof.

According to another embodiment, a non-transitory computer-readable storage medium having stored thereon one or more program instructions which, when executed by one or more processors, cause, at least in part, an apparatus to determine contextual data associated with a trip request, a plurality of candidate vehicles available to complete the trip request, a plurality of candidate modes of vehicle operation available to complete the trip request, or a combination thereof. The apparatus is also caused to process the contextual data to calculate respective energy-efficiency scores, respective convenience factors, or a combination thereof for the plurality of candidate vehicles, the plurality of candidate modes of vehicle operation, or a combination thereof. The apparatus is further caused to selecting a recommended vehicle, a recommended mode of vehicle operation, or a combination thereof based on a balancing of the respective energy-efficiency scores and the respective convenience factors. The apparatus is further caused to provide data for presenting the recommended vehicle, the recommended mode of vehicle operation, or a combination thereof.

According to another embodiment, an apparatus comprises means for determining contextual data associated with a trip request, a plurality of candidate vehicles available to complete the trip request, a plurality of candidate modes of vehicle operation available to complete the trip request, or a combination thereof. The apparatus also comprises means for processing the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request. The apparatus further comprises means for selecting a recommended vehicle, a recommended mode of vehicle operation, or a combination thereof based on the respective energy-efficiency scores. The apparatus further comprises means for providing data for presenting the recommended vehicle, the recommended mode of vehicle operation, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a contextually relevant vehicle comparison for a given trip, according to example embodiment(s);

FIG. 2 is an illustrative example of all the shared vehicle options available in a given area;

FIG. 3 is a diagram of the components of a mobility platform, according to example embodiment(s);

FIG. 4 is a flowchart of a process for providing a contextually relevant vehicle comparison for a given trip, according to example embodiment(s);

FIGS. 5A through 5D are diagrams of example user interfaces for providing a contextually relevant vehicle comparison for a given trip, according to example embodiment(s);

FIGS. 6A and 6B are diagrams of example user interfaces for providing a contextually relevant vehicle comparison for a given trip, according to example embodiment(s);

FIG. 7 is a diagram of a geographic database, according to example embodiment(s);

FIG. 8 is a diagram of hardware that can be used to implement example embodiment(s);

FIG. 9 is a diagram of a chip set that can be used to implement example embodiment(s); and

FIG. 10 is a diagram of a mobile terminal (e.g., handset or vehicle or part thereof) that can be used to implement example embodiment(s).

### DESCRIPTION OF SOME EMBODIMENTS

Examples of a method, apparatus, and computer program for providing a contextually relevant vehicle comparison for a given trip are disclosed. In the following description, for the purposes of explanation, numerous specific details are set forth to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention.

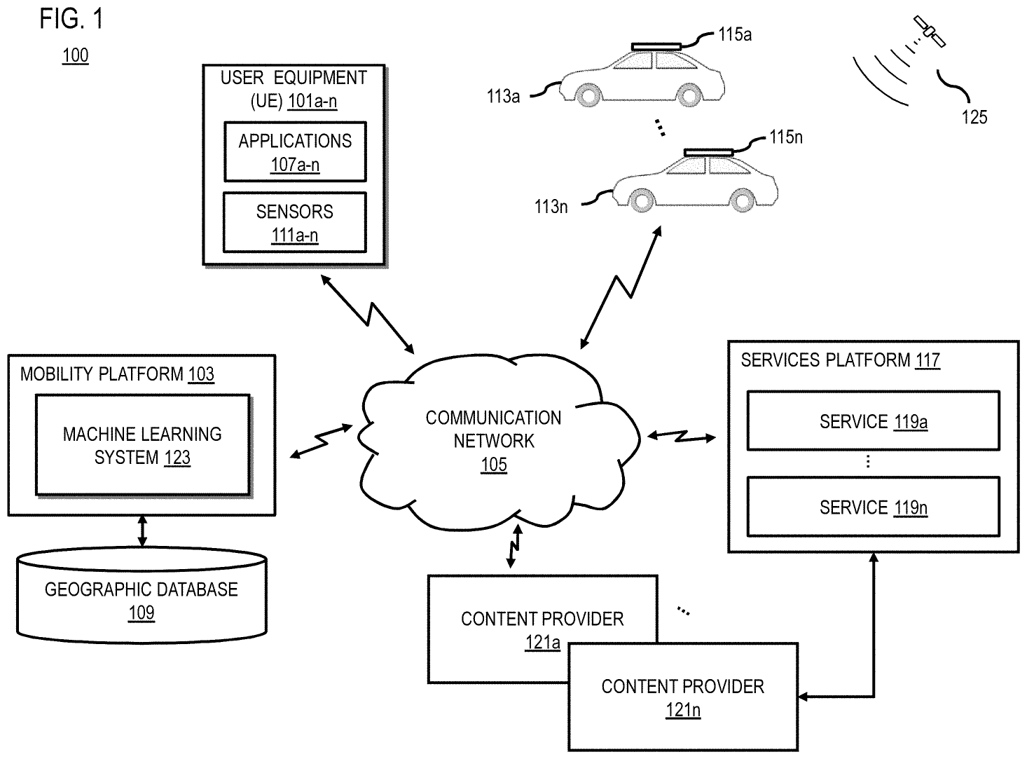

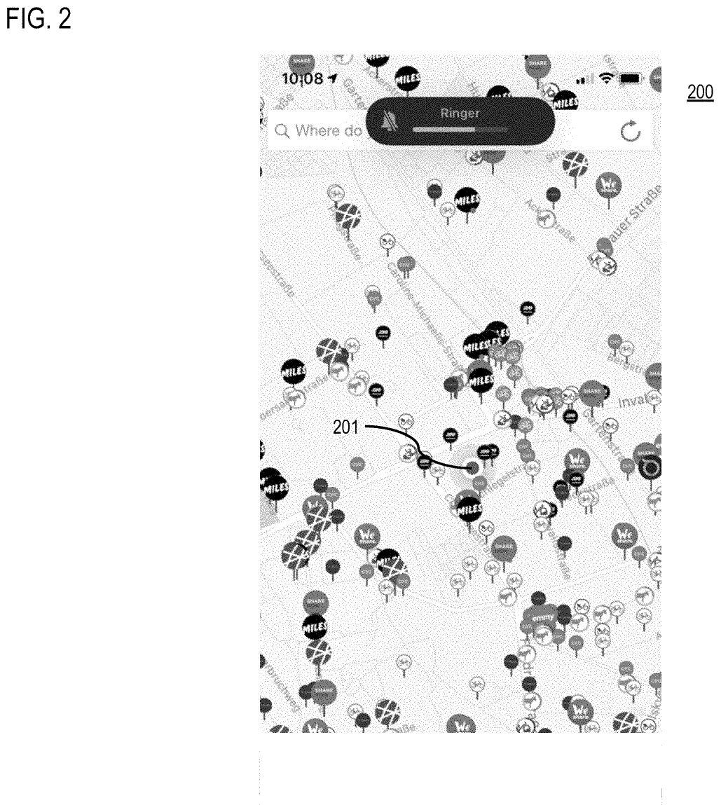

FIG. 1 is a diagram of a system capable of providing a contextually relevant vehicle comparison for a given trip, according to example embodiment(s). As described above, location-based service providers (e.g., mapping and navigation providers) are continually challenged to provide compelling services and applications. One area of development relates to providing navigation guidance and/or other mapping-related information via various means or modes of transportation (e.g., private transportation, public transportation, shared vehicles, walking, etc.). While many users may prefer using private modes of transportation (e.g., based on convenience, familiarity, etc.), there is also a growing trend towards more energy efficient vehicle usage (e.g., to reduce environmental impact, pollution, vehicle ownership costs, taxes, etc.).

Consequently, vehicle sharing or mobility services (e.g., shared cars, shared scooters, shared bicycles, shared rollers, etc.) are increasingly becoming a popular alternative to both private and public modes of transportation, for example, due to the advantages that they can provide in terms of energy efficiency (e.g., carpooling, less vehicles on the road, etc.) and convenience (e.g., flexibility as to when and where vehicles can be picked up and dropped off, not being restricted to a static public transportation system, etc.). However, as the overall number of options and complexity of corresponding attributes and variables to be considered increases, service providers face significant technical challenges to convey all the various options in a way that is contextually or personally relevant and easily understood (e.g., while using a mobile device, a smartphone, etc.).

Current navigation systems can provide some energy-related route guidance relative to various means or modes of transportation for a given trip. For example, such systems may be able to compute “green”/energy efficient routes that waste less energy, provide car-pooling options, maximize the number of passengers per vehicle, etc. However, these systems are generally unable to recommend vehicles from pools (e.g., shared vehicles) based on a wider context of consideration (e.g., all contextually available information). Moreover, there may be hundreds of shared vehicles owned and/or operated by different mobility operators in a given area (e.g., a city center) and the presentation of all these options (e.g., via a mobile device, a smartphone, etc.) can easily overwhelm a user, resulting in poor user experience. An illustrative example of all the shared vehicle options available in a given area 200 (e.g., based on a user location 201) is depicted in FIG.

2.

By way of example, with all the possible options due to the many attributes and variables to be considered (e.g., the vehicles, the trip, user preferences, etc.), a user (e.g., a vehicle driver, a passenger, etc.) may have cognitive difficulty selecting the most suitable vehicle for a given trip (e.g., balancing energy consumption and convenience). Similarly, without requiring all users to register with all mobility services (e.g., providing user preferences, etc.), a user (e.g., a shared vehicle service, a municipality, etc.) may have cognitive difficulty quickly analyzing all the attributes and variables to determine, for example, where to locate certain vehicles (e.g., drop off and/or pick up locations) to minimize its ecological impact as well as maximize profitability. For example, by placing shared vehicles in locations where they are likely to be used with multiple passengers, such services can possibly maximize their ecological impact, moving away from one person per vehicle. Accordingly, service providers face significant technical challenges to provide a basis for comparing all the various transportation options in a way that is contextually relevant and easily understood.

To address these technical problems, a system 100 of FIG. 1 introduces a capability to provide a contextually relevant vehicle comparison for a given trip, according to example embodiment(s). In one embodiment, the system 100 enables a user (e.g., a vehicle driver, a passenger, a vehicle sharing service, a municipality, etc.) to get personalized recommendations of the most energy efficient vehicles to be used (e.g., driven, located, etc.) for a specific trip by considering all contextually available information. In one instance, the system 100 first determines a route guidance trip request (e.g., between two points of interest (POIs)). By way of example, the system 100 may determine the trip request based on a user's input of an origin, a destination, a desired time of travel, one or more user preferences (e.g., avoid toll roads), etc. (e.g., via a navigation application, a shared vehicle reservation application, etc.). The system 100, in one embodiment, can then collect all available relevant contextual and environmental information related to (1) the vehicles, (2) the trip, and (3) user preferences. By way of example, the relevant contextual and environmental information or data may be a function of one or more of the following example considerations:
Attributes of all available vehicles (fuel/electric vehicle (EV) charging, number of seats, transmission type, trunk size, etc.);
Number of passengers for the trip;
Trip length;
Distance to all available vehicles to be considered as vehicle candidates;
Prices of all options including using one's own vehicle (if possible);
Coverage areas of all shared vehicles (e.g., operational areas);
User convenience for each vehicle (familiarity with the car model, space, etc.);
Whether the same vehicle is needed for the return journey or whether the user can use another transport mode;
Available travel options (public transport, shared bikes, ride hailing, etc.);
Traffic conditions;
Pollution levels; or
Parking conditions at a destination (and when coming back).

In one embodiment, the system 100 can determine the information or data from vehicle sharing services, traffic services, weather services, governmental and/or non-governmental services (e.g., historical mobility patterns, parking regulations, etc.), user input, and/or user mobility patterns, etc.

In one embodiment, the system 100 can use contextual and environmental information or data to compute an index which shows the efforts made (or not made) by people to be energy cautious/efficient with respect to a given trip (e.g., using private transportation, public transportation, shared vehicles, walking, etc.). In one instance, the system 100 can compute an index/score value per candidate vehicle (e.g., based on gas mileage, emissions, etc.). In one embodiment, the system 100 can also determine a measure of efficient vehicle usage not only as a function of the vehicle but also as a function of how “good/efficient” the vehicle is being utilized. For example, the system 100 may compute a relatively low score for one user travelling in a very large and polluting vehicle, consuming lots of gas/energy for a long trip. In contrast, the system 100 may compute a relatively high score for a four person family that is making some effort (e.g., walking approximately 400 meter (m) away) to take a small electric shared vehicle just fitting their need for a rather short trip. In this instance, the system 100 could compute a relatively high score due to the high energy efficiency of the vehicle, the low emission, and the effort made by the family to reach the vehicle. It is contemplated that the system 100 could compute an even higher score if the family walked to take the small EV although one or more family vehicles were closer and/or nearby. In one embodiment, the system 100 can compute the score based on a ratio between energy related factors and user preference parameters.

In one instance, the system 100 can rank all the possible vehicle options based on the respective index/scores and then present the vehicles to a user based on their respective ranks (e.g., via a navigation application, a shared vehicle reservation application, etc.) to support user decision making. By way of example, the presentation by the system 100 may include an ordering, their relative scores, etc. In one embodiment, the system 100 may only present vehicle(s) or mode(s) of transportation that meet a certain threshold ranking (e.g., 1^{st} through 3^{rd}) rather than all possible vehicle options to minimize potential user distraction and/or frustration. For example, a user may not want to spend the time or the energy to differentiate between a vehicle ranked 5^{th} among the candidate vehicles and a vehicle ranked 6^{th}. Likewise, presenting the ranking for all possible vehicle options can in some instances consume considerable memory on a user device (e.g., a mobile device or a smartphone).

The system 100, in one embodiment, can keep or save a history of contexts (e.g., information and vehicle attributes, proximities, environmental factors, etc.) at the time a trip request is made. In on embodiment, the system 100 can index or tag the information or data so that the system 100 can access the information or data as an input for later processing. By way of example, the tagged or indexed information or data may be utilized by the system 100 as a label for supervised machine learning so that the system 100 can improve the efficiency of subsequent vehicle rankings and/or comparisons (e.g., with respect to similar trip requests).

In one embodiment, the system 100 of FIG. 1 can determine a trip request from a user (e.g., an individual) via one or more user equipment (UE) 101a-101n (also collectively referred to herein as UEs 101) (e.g., a mobile device, a smartphone, etc.) having connectivity to a mobility platform 103 via the communication network 105. In one instance, the UEs include one or more applications 107a-107n (also collectively referred to herein as applications 107) (e.g., a navigation application, a mapping application, a shared vehicle reservation application, etc.) which a user can use to make or research a trip request and the system 100 can use to determine that a trip request is being made or researched. By way of example, a user may want route guidance to an unknown location (e.g., a new restaurant) including various means or modes of transportation or the user may want to know the various means or modes of transportation available to take to a known location to try one or more different modes (e.g., a bike versus a car), or one or more a different combinations (e.g., walking to a shared bike dock and then biking to work) to potentially reduce her energy consumption for a given trip.

In one embodiment, based on the trip or guidance request, the system 100 can collect contextually available information and data related to (1) the possible vehicles (2) the trip, and/or (3) user preferences. In one instance, the system 100 can access and/or collect contextually relevant information or data related to the trip and/or the user preferences via the applications 107 (e.g., a navigation application, a shared vehicle reservation application, etc.), the geographic database 109 (e.g., user mobility patterns, stored user preferences, etc.), or a combination thereof. In one embodiment, the UEs 101 include or one or more device sensors 111a-111n (also collectively referred to herein as device sensors 111) (e.g., global positioning system (GPS) sensors) that the system 100 can also use to collect such information or data. In one embodiment, the system 100 can use the applications 107 and/or the device sensors 111 (e.g., GPS sensors) to determine a trip origin, a trip completion, a trip length, number of passengers for a trip (e.g., based on inputted data, proximity of different UEs 101, etc.), or a combination thereof.

In one embodiment, the system 100 includes one or more vehicles 113a-113n (also collectively referred to herein as vehicles 113) (e.g., private vehicles, public vehicles, shared vehicles, etc.) for completing a given trip. In one instance, the vehicles 113 have connectivity to the mobility platform 103 via the communication network 105 and include one or more vehicle sensors 115 (also collectively referred to as vehicle sensors 115) (e.g., camera sensors, GPS sensors, thermal sensors, etc.). In one embodiment, the system 100 can access and/or collect contextually relevant information or data related to the vehicles 113 from the vehicle sensors 115 (e.g., GPS sensors), a UE 101 associated with a vehicle 113 (e.g., an embedded navigation system), one or more mobility operators or providers (e.g., shared vehicle services, ride hailing services, “classic” public transport services, etc.), the geographic database 109 (e.g., historical mobility patterns), or a combination thereof. By way of example, the contextually relevant information or data may include all alternative transportation options relative to a private vehicle 113 (e.g., public transport, shared bikes, ride hailing vehicle, etc.). In addition, the information or data may include attributes of all the available vehicles 113 (e.g., vehicles 113 within a threshold proximity of the user, vehicles 113 not already reserved, vehicles 113 in working order, etc.). In one instance, the vehicle attributes, in addition to those described above, may also include engine type (e.g., gas or EV), number of seats, transmission type (e.g., manual or automatic), trunk size, etc. Further, contextually relevant information or data may include the proximity of each vehicle 113 to a requesting user (e.g., a distance or an amount of effort that a user may have to exert to reach the vehicle 113 before starting a given trip), vehicle option prices and/or operating costs (e.g., fuel consumption, reservation and usage costs, etc.), relative emissions or pollution, relative coverage or operational areas for shared vehicles 113, etc. Although depicted as automobiles, it is contemplated that the vehicles 113 can be any type of passenger vehicle or mobility apparatus, including ride hailing or ride sharing vehicles manned or unmanned (e.g., car, trucks, buses, trains, trams, trolleys, subways, motorcycles, scooters, bicycles, rollers, drones, etc.) capable of enabling a user to complete a given trip.

In one instance, the system 100 can also access or collect contextually relevant information or data related to the trip from a services platform 117, one or more services 119a-119n (also collectively referred to as services 119) (e.g., traffic services, weather services, etc.), one or more content providers 121a-121n (also collectively referred to as content providers 121) (e.g., map developers), or a combination thereof. By way of example, the information or data related to the trip, the vehicles 113, or a combination may include road attributes (e.g., width, size, directionality, etc.), traffic data, on street parking around trip destination(s), weather, parking restrictions, on street parking availability from real-time parking street management systems, known locations for emergency infrastructure (e.g., fire hydrants), nearby event data (e.g., street fairs, festivals, etc.), cost of street parking, etc.

In one embodiment, the system 100 can compute an index/score value per candidate vehicle 113 (“Green-ness value”) for a given trip or route based on all the available contextually relevant information (e.g., using the machine learning system 123). In one instance, the system 100 computes the score as a ratio between energy related factors and user preference parameters. As previously mentioned, the system 100 can also compute the index/score as a function of how “good/efficient” a vehicle 113 is being utilized for a given trip. By way of example, the system 100 may compute a relatively high score for a group of users that want to share a small/medium size autonomous vehicle 113 that is already in proximity to the group. It is contemplated that the system 100 could compute an even higher score if the system 100 knows that the users of this group usually default to using one vehicle 113 each when traveling (e.g., based on information or data stored in or accessed via the geographic database 109). Thus, traveling together for the given trip is relatively more efficient than using x vehicles 113. In contrast, the system 100 may compute a relatively low score for an individual user that wants to use a larger autonomous vehicle 113 (e.g., a SUV) that needs to travel autonomously from a remote location. In one embodiment, the system 100 can rank all the available contextually relevant information using an even weight distribution. Alternatively, or in addition, the system 100 can independently weight various information and data corresponding to vehicle suitability or energy efficiency. For example, the system 100 can determine that certain data (e.g., engine type) should be weighted relatively more in connection with the ranking (e.g., versus trunk size). In one embodiment, the system 100 can store the applicable factors and attributes, contextually relevant information related to the vehicles 113, trip information or data, user preferences, respective weights or weighting schemes, etc. in the geographic database 109 as labeled or marked features for subsequent use and/or training of the machine learning system 123 to improve the speed and accuracy of the system 100's vehicle 113 ranking and/or comparison process.

By way of example, if the system 100 determines that a requesting user owns a vehicle 113 (e.g., based on information stored in or accessed via the geographic database 109), the system 100 can first compute a score for the user's vehicle and then compute scores for all alternative vehicles 113 (e.g., within a threshold proximity) to determine if any of the alternatives may be a more suitable option (e.g., balancing energy efficiency and convenience). For example, the system 100 can score a much smaller shared vehicle 113 parked near the user much higher and, therefore, as a more suitable option relative to taking a short trip alone in the user's much larger vehicle 113 (e.g., a SUV). In one embodiment, if the system 100 determines that a requesting user does not own a vehicle 113, the system 100 can prioritize (e.g., score higher) shared vehicles 113, public transportation vehicles 113, or other suitable means (e.g., to promote energy efficiency).

By way of another example, the system 100 may determine that a user is planning an approximately 45 min trip (e.g., across a city center) and that there are three vehicles 113 available within a threshold proximity. For example, Vehicle 1 is a large SUV that is 100 m away from the users; Vehicle 2 is a small 4-seater gas-powered car that is 300 m away from the users; and Vehicle 3 is a 2-seater EV smart car that is 1.2 kilometer (km) away. In one embodiment, the system 100 may compute the respective scores and ranks as follows:
Vehicle 1: Score 2000 (Rank 3)
Vehicle 2: Score 300 points (Rank 1)
Vehicle 3: Score 500 points (Rank 2)

In this instance, the system 100 scored Vehicle 2 better (lower) than Vehicle 3, despite having lower emissions and/or more pollution, because the system 100 took into consideration or balanced the potential energy savings compared to the likely user effort and/or convenience. In other words, the system 100 can determine that the inconvenience of walking 1.2 km rather than 300 m outweighs the potential 200-point energy efficiency savings.

In one embodiment, the system 100 provides a personalized recommendation of the most energy efficient vehicle (e.g., balancing energy efficiency and convenience) to be used for a specific trip by considering all contextually available information. The point being that the system 100 can programmatically recommend (e.g., using the machine learning system 123) the “best vehicle 113 for a trip” based, for example, on ecological considerations and the context of that trip (and not to find out that riding a bike 113 for a daily commute is more carbon dioxide (CO₂)-efficient). In one instance, the system 100 presents the recommendation via an application 107 (e.g., a navigation application, shared vehicle reservation application, etc.) in an easily readable or digestible manner (e.g., as a comparative view of options). In one instance, the system 100 can provide the respective rankings and their relative scores to support decision making. In one embodiment, the system 100 may only present those vehicles 113 with at least a certain threshold rank or score (e.g., vehicles ranked 1^{st} through 3^{rd}) to ensure that information can be quickly and easily understood. For example, in many instances, users review such rankings and scores via a UE 101 (e.g., a mobile device or smartphone) which often allows for limited visual real estate. Moreover, presentation of an overabundance of vehicle options can quickly frustrate and/or distract the user as described above, leading to poor user experience.

In one instance, the system 100 can determine whether the user acknowledged the proposal (e.g., via an input or gesture in connection with an application 107) or used the recommended vehicle 113 for the trip (e.g., based on device sensors 111, vehicle sensors 115, or a combination thereof). In one embodiment, the system 100 can reward a selection of a recommended vehicle 113 and/or penalize a selection of lower ranked vehicles 113. By way of example, a reward may include points, discounts, priority bookings or reservations, vehicle upgrades, lower vehicle taxes, greater flexibility with respect to pick up and drop off locations and/or times, etc. In contrast, a penalty may include longer waits or queues for bookings or vehicle availability, limited vehicle access (e.g., lower ranked vehicles), higher vehicle taxes, reduced flexibility with respect to pick up and drop off locations and/or times, etc.

In one embodiment, the system 100 can update the vehicle 113 and user metrics after the completion of the trip. By way of example, the system 100 can update or modify the labeled data or marked features previously saved or stored in the geographic database 109 for subsequent use and/or training of the machine learning system 123

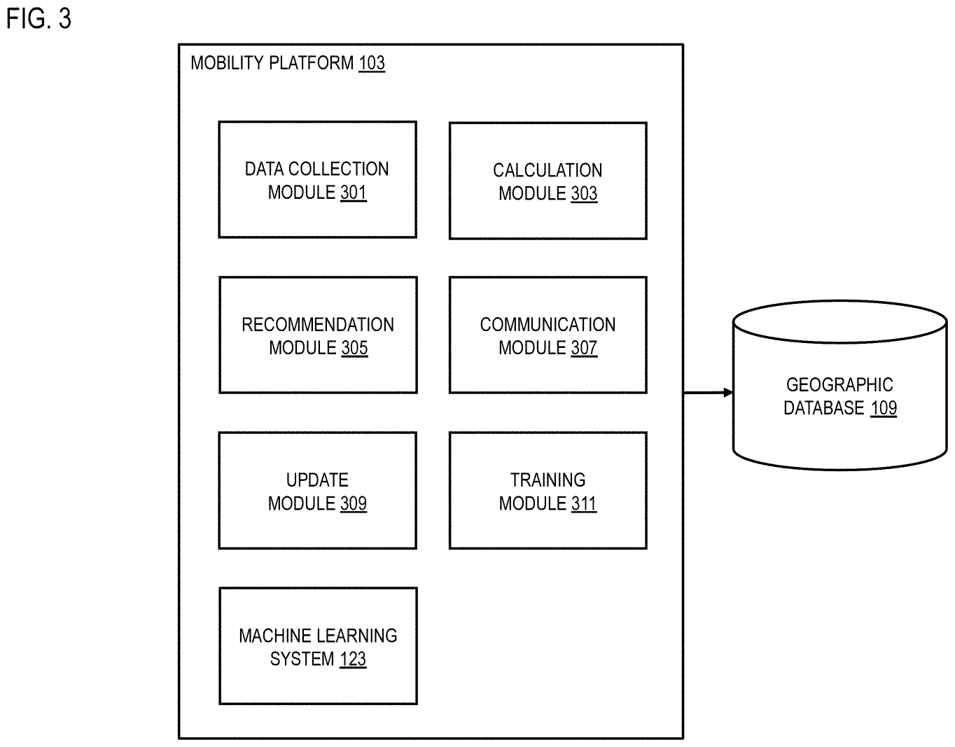

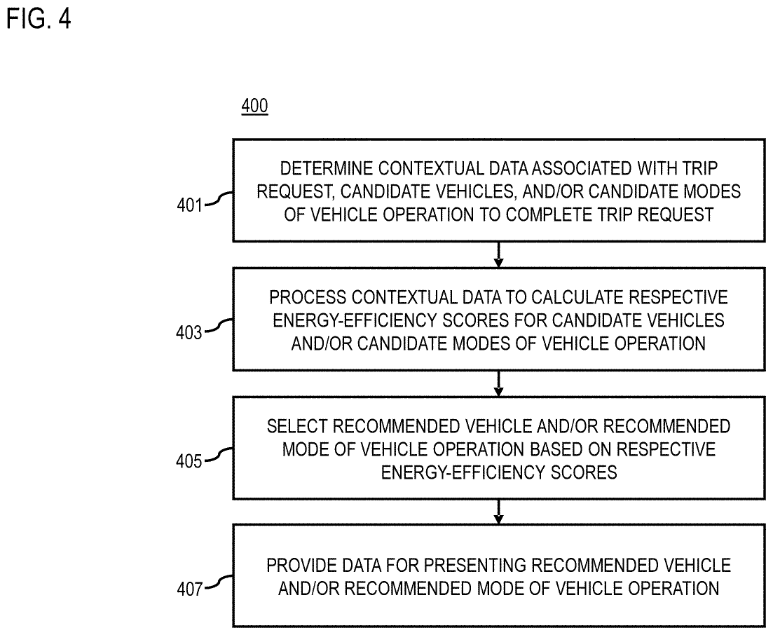

FIG. 3 is a diagram of the components of the mobility platform 103, according to example embodiment(s). By way of example, the mobility platform 103 includes one or more components for providing a contextually relevant vehicle comparison for a given trip, according to the example embodiment(s) described herein. It is contemplated that the functions of these components may be combined or performed by other components of equivalent functionality. In one embodiment, the mobility platform 103 includes a data collection module 301, a calculation module 303, a recommendation module 305, a communication module 307, an update module 309, a training module 311, and the machine learning system 123, and has connectivity to the geographic database 109. The above presented modules and components of the mobility platform 103 can be implemented in hardware, firmware, software, or a combination thereof. Though depicted as a separate entity in FIG. 1, it is contemplated that the mobility platform 103 may be implemented as a module of any other component of the system 100. In another embodiment, the mobility platform 103, the machine learning system 123, and/or the modules 301-311 may be implemented as a cloud-based service, local service, native application, or combination thereof. The functions of the mobility platform 103, the machine learning system 123, and/or the modules 301-311 are discussed with respect to FIG. 4.

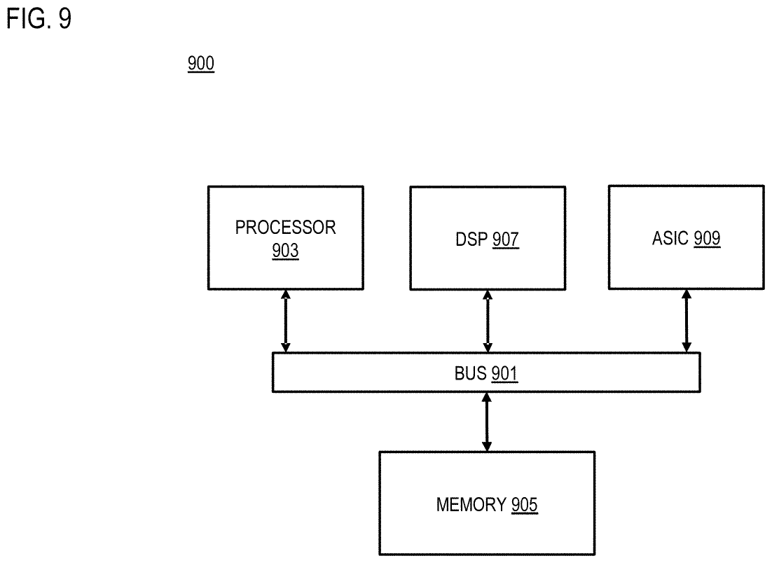

FIG. 4 is a flowchart of a process for providing a contextually relevant vehicle comparison for a given trip, according to example embodiment(s). In various embodiments, the mobility platform 103, the machine learning system 123, and/or any of the modules 301-311 may perform one or more portions of the process 400 and may be implemented in, for instance, a chip set including a processor and a memory as shown in FIG. 9. As such, the mobility platform 103, the machine learning system 123, and/or the modules 301-311 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In step 401, the data collection module 301 can determine contextual data associated with a trip request, a plurality of candidate vehicles 113 available to complete the trip request, a plurality of candidate modes of vehicle operation available to complete the trip request, or a combination thereof. By way of example, the contextual data collected by the data collection module 301 may be data that the recommendation module 305 would need to determine or recommend the “most suitable” vehicle 113 for a given trip (e.g., balancing energy consumption and convenience). In one embodiment, the contextual data includes at least one of:
attribute data of the plurality of candidate vehicles, the plurality of candidate modes of vehicle operation, or a combination thereof;
a number people associated with a trip request;
a trip length;
a distance to the plurality of candidate vehicles 113;
pricing data for the plurality of candidate vehicles 113, the plurality of candidate modes of vehicle operation, or a combination thereof;
operational areas for shared vehicles 113 of the plurality of candidate vehicles 113;
historical user experience data with the plurality of candidate vehicles 113, the plurality of candidate modes of vehicle operation, or a combination thereof;
weather data;
traffic data;
parking data;
nearby event data; or
road attribute data.

In one instance, a trip request (e.g., for a route or route guidance) may include a single leg or direction of travel, a trip to a destination and a return trip from the destination (e.g., a round trip), or a combination thereof. In one embodiment, the plurality of candidate vehicles 113 includes one or more user vehicle 113 (e.g., private vehicles), one or more shared vehicles 113 (e.g., shared cars, shared scooters, etc.), one or more public transportation vehicles 113 (e.g., buses, subways, trams, etc.), or a combination thereof. By way of example, the candidate modes of vehicle operation may include various modes of locomotion (e.g., such as gas and/or electric powered in a hybrid vehicle); various modes of control (e.g., driver control versus autonomous or semi-autonomous control); various numbers of passengers (e.g., minimum or maximum seat utilization), various modes of cost (e.g., avoiding all toll roads), various temporal or environmental modes (e.g., certain days of the week, time of day, weather, etc.), or a combination thereof.

In step 403, the calculation module 303 can process the contextual data to calculate respective energy-efficiency scores for the plurality of candidate vehicles 113, the plurality of candidate modes of vehicle operation, or a combination thereof, wherein each of the respective energy-efficiency scores respectively indicate a predicted energy efficiency to complete the trip request. In one instance, as described above, the predicted energy efficiency to complete a trip may be a function of a vehicle 113 (e.g., energy efficiency, miles/kilometers per gallon, battery utilization, emission levels or pollution, etc.); a function of how good/efficiently a vehicle 113 is being used (e.g., one person taking a large car for a short trip versus taking a smaller car or bike); or a combination thereof. By way of example, the respective energy-efficiency scores respectively indicate a predicted energy efficiency because in some instances an unforeseen event (e.g., traffic or an accident) or a change in circumstances (e.g., a snow storm) may affect the ultimate energy efficiency of a vehicle 113 during and/or at completion of the trip.

In one embodiment, the calculation module 303 can calculate respective energy-efficiency scores for the plurality of candidate vehicles 113, the plurality of candidate modes of vehicle operation, or a combination thereof based on all collected contextual data using an evenly weighted distribution. For example, the calculation module 303 may assign the same weight to the number of people associated with the trip request as an attribute of a vehicle 113 (e.g., gas powered, electric powered, etc.). Alternatively, or in addition, the calculation module 303 can determine that in some instances certain collected contextual data (e.g., engine type, trip length, occupancy, etc.) should be weighted relatively more in connection with calculating the respective energy-efficiency score (e.g., versus weather). In one embodiment, the calculation module 303 can store the respective weights or weight schemes corresponding to the contextual data, a user, a vehicle 113, a mode of vehicle operation, or a combination thereof in the geographic database 109 as labeled or marked features for future use and/or training of the machine learning system 123 to improve the speed and accuracy of the respective energy-efficiency scores and/or respective predicted energy efficiency.

In step 405, the recommendation module 305 can select a recommended vehicle 113, a recommended mode of vehicle operation, or a combination thereof based on the respective energy-efficiency scores. In other words, the recommendation module 305 can select a vehicle 113, a mode of vehicle operation, or a combination thereof to recommend to a user (e.g., an individual, a vehicle sharing service, an autonomous vehicle network, etc.). By way of example, the recommendation module 305 may select the vehicle 113 with the highest calculated energy-efficiency score, any number of vehicles 113 with a calculated energy-efficiency score above a certain threshold, or a combination thereof. For example, the recommendation module 305 may select the recommended vehicles 113 based on the top three respective energy-efficiency scores among the plurality of candidate vehicles 113.

In one embodiment, the calculation module 303 can process the contextual data to calculate respective convenience factors for the plurality of candidate vehicles 113, the plurality of candidate modes of vehicle operation, or a combination thereof, wherein each of the respective convenience factors respectively represent a predicted accessibility, a predicted familiarity, or a combination thereof. By way of example, a predicted accessibility may include a distance to a vehicle 113 as well as an amount of effort required to reach a vehicle 113 (e.g., a flat paved street versus a rocky hill path), user demand, reservation and/or operation costs, coverage area or time limit restrictions, handicap accessibility, etc. A predicted familiarity, for example, may include familiarity with the specific vehicle 113 or the type of vehicle 113 (e.g., in terms of operation as well seating/space). In one example, the predicted familiarity may also include a familiarity with a means or modes of transportation. For example, a user's familiarity with using public transportation (e.g., ticket purchasing, boarding, exiting, etc.) and/or a shared vehicle 113 (e.g., reserving, picking up, and/or dropping off, etc.).

In one instance, the recommended vehicle 113, the recommended mode of vehicle operation, or a combination thereof is selected further (e.g., by the recommendation module 305) based on respective convenience factors. In one embodiment, the recommended vehicle 113, the recommended mode of vehicle operation, or a combination thereof is selected further (e.g., by the recommendation module 305) based on a balancing of the respective energy-efficiency scores and the respective convenience factors.

In step 407, the communication module 307 can provide data for presenting the recommended vehicle 113, the recommended mode of vehicle operation, or a combination thereof. By way of example, the data may be provided to an application 107 (e.g., a navigation application, a shared vehicle reservation application, etc.) of a UE 101 (e.g., a mobile device, a smartphone, etc.) or in the case of an autonomous or semi-autonomous vehicle 113, the data may be provided to a UE 101 (e.g., an embedded navigation system) and/or directly to the vehicle 113. For example, the provision of the data by the communication module 307 to an autonomous vehicle 113 could cause an autonomous vehicle 113 to start a route towards a user or start a route towards a designated pick up location.

In one embodiment, the data for presenting the recommended vehicle 113, the recommended mode of vehicle operation, or a combination thereof can be presented in a user interface (e.g., a navigation application 107) that provides a comparative view, for example, of the recommended vehicle 113, the recommended mode of vehicle operation, the plurality of candidate vehicles 113, the plurality of candidate modes of vehicle operation, or a combination thereof. In one instance, the comparative view may include a representation of the respective energy-efficiency scores of the recommended vehicle 113, the recommended mode of vehicle operation, the plurality of candidate vehicles 113, the plurality of candidate modes of vehicle operation, or a combination thereof. By way of example, the representation of the respective energy-efficiency scores may include a relative positioning or placement of the recommended vehicles 113 within an application 107 (e.g., a navigation application), a relative graphical rendering or representation of the recommended vehicles 113 (e.g., arranged by size, color, etc.), a relative symbol or designation corresponding to the recommended vehicles 113 (e.g., stars, bars, etc.).

In one embodiment, the user interface (e.g., an application 107) can provide a user interface element (e.g., an input) for specifying a target energy-efficiency score. In one instance, the target energy-efficiency score can then be used to select, sort, filter, or a combination thereof the recommended vehicle 113, the recommended mode of vehicle operation, the plurality of candidate vehicles 113, the plurality of candidate modes of vehicle operation, or a combination thereof.

In one instance, the user interface (e.g., an application 107) may be a component of a ride-sharing service (e.g., a vehicle sharing or mobility provider). In such cases, the recommendation module 307 may select the recommended vehicle 113 from the plurality of candidate vehicles 113, the plurality of candidate modes of vehicle operation, or a combination thereof that is part of a vehicle fleet of a ride-sharing service. By way of example, a ride-sharing service provider can use the selection of recommended vehicles 113 to allocate such vehicles 113 to various pick up and drop off locations to maximize its environmental impact and/or profitability (e.g., ensuring maximum use of a vehicle 113).

In one embodiment, the calculation module 303 can monitor the contextual data, the respective convenience factors, or a combination thereof during or after a completion of a trip request. By way of example, the calculation module 303 can count or tally the number of times that a user was willing to use a shared vehicle 113 with strangers, alone, with other family members, etc. In another example, the calculation module 303 can count or tally the number of times that a user was willing to walk 200 m or more to reach an electric shared vehicle 113 rather than using her own vehicle 113 or a gas-powered vehicle 113. In one instance, the update module 309 updates the respective energy-efficient scores based on the monitoring.

In one embodiment, the training module 311 in connection with the machine learning system 123 can select and/or update the respective weights or weighting scheme related to the contextual data, the respective convenience factors, the balancing of the respective energy-efficiency scores and the respective convenience factors, or a combination thereof based on the monitoring during or after a completion of a trip. In one instance, the training module 311 can continuously provide and/or update a machine learning module (e.g., a support vector machine (SVM), neural network, decision tree, etc.) of the machine learning system 123 during training using, for instance, supervised deep convolution networks or equivalents. In other words, the training module 311 trains a machine learning model using the respective weights of the contextual data, the respective convenience factors, the balance of the respective energy-efficiency scores and the respective convenience factors, or a combination thereof to enable the recommendation module 305 to most efficiently select the recommended vehicle 113, the recommend vehicle operation mode, or a combination thereof and/or to improve the likelihood that a user ultimately selects the recommended vehicle 113 or the recommend mode of vehicle operation for a given trip.

In one embodiment, the calculation module 303 can initiate an adjustment, an incentive, a penalty, or a combination thereof based on determining that a user has selected the recommended vehicle, a vehicle other than the recommended vehicle (i.e., rejecting the vehicle recommended by the recommendation module 305), the recommended mode of vehicle operation, or a mode of vehicle operation other than the recommended mode of vehicle operation (i.e., rejecting the mode of vehicle operation recommended by the recommendation module 305), or a combination thereof. In one instance, the adjustment, the incentive, the penalty, or a combination thereof may be based on a difference between the respective energy-efficient scores of the selected vehicle and the recommended vehicle 113, the selected mode of vehicle operation and the recommended mode of vehicle operation, or a combination thereof. By way of example, an incentive may be a reduced cost for a past, present, or future trip and a penalty may be an increased cost or a tax for a past, present, or future trip.

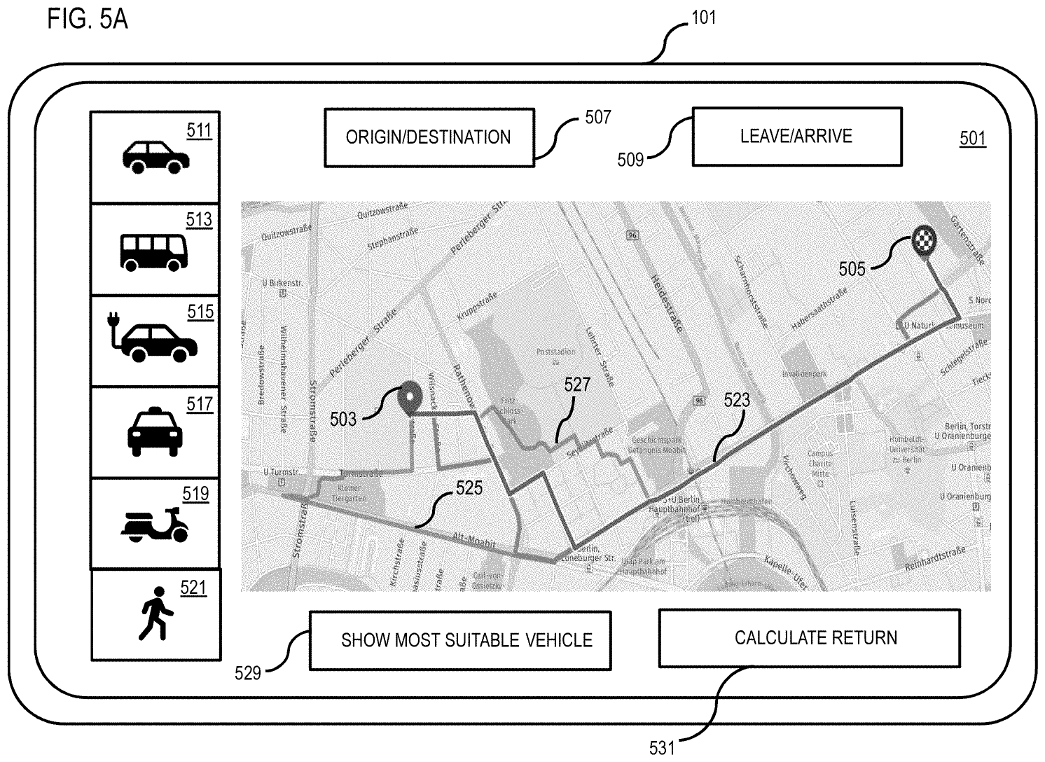

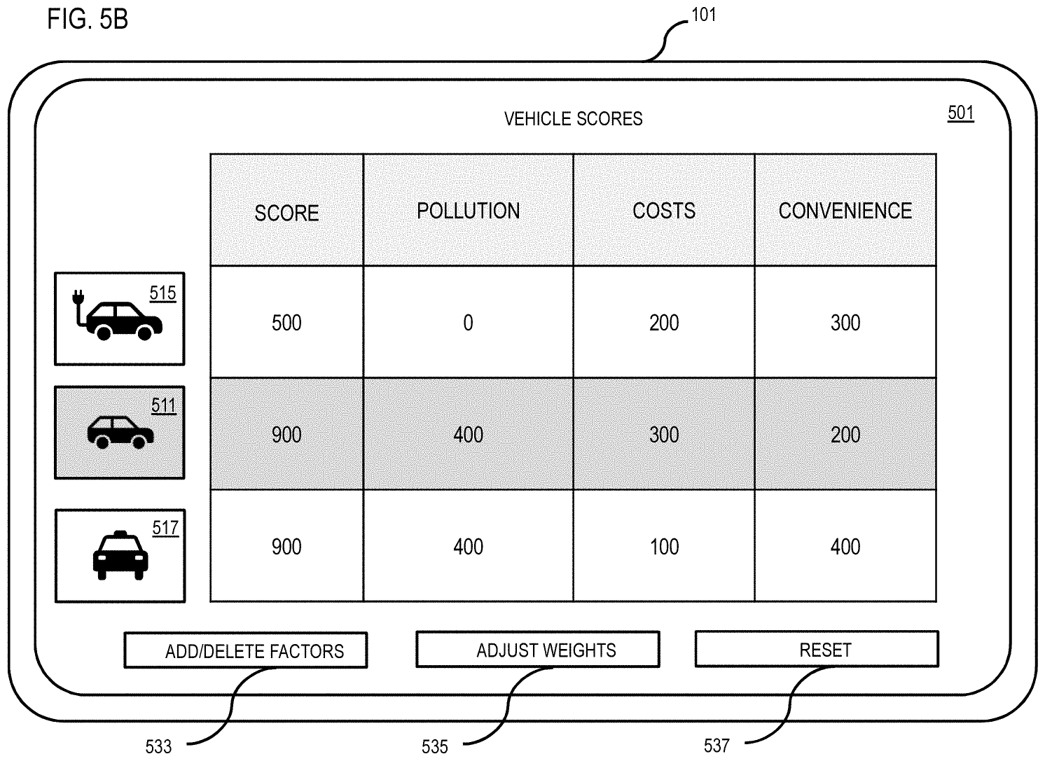

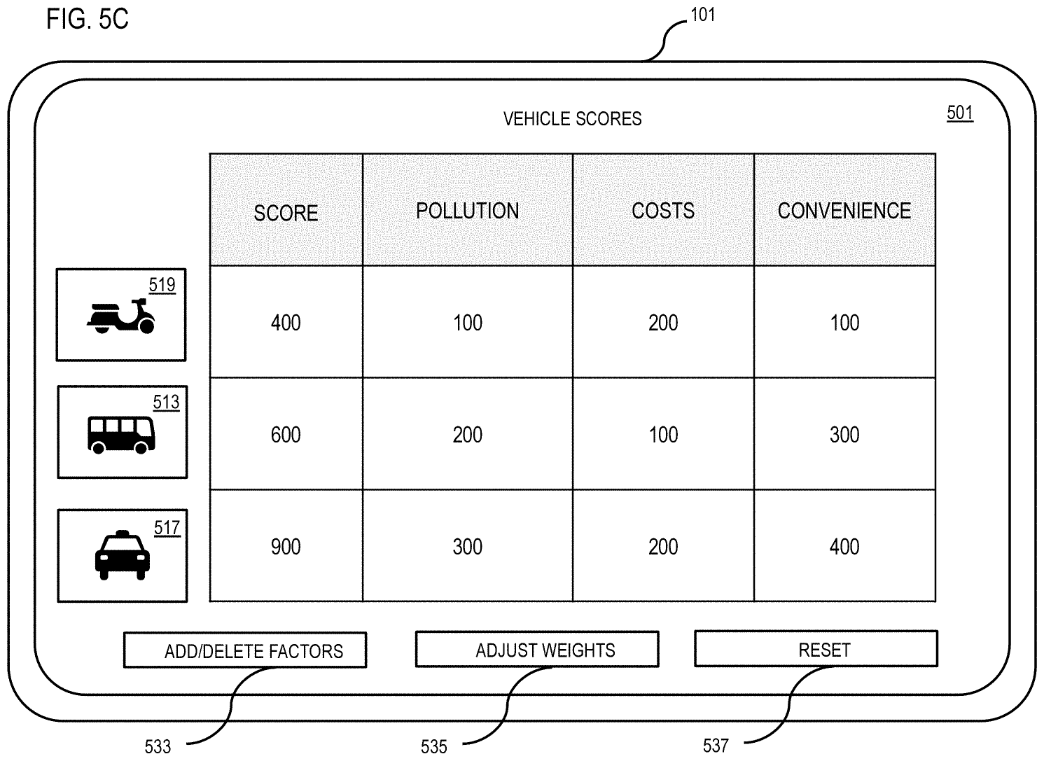

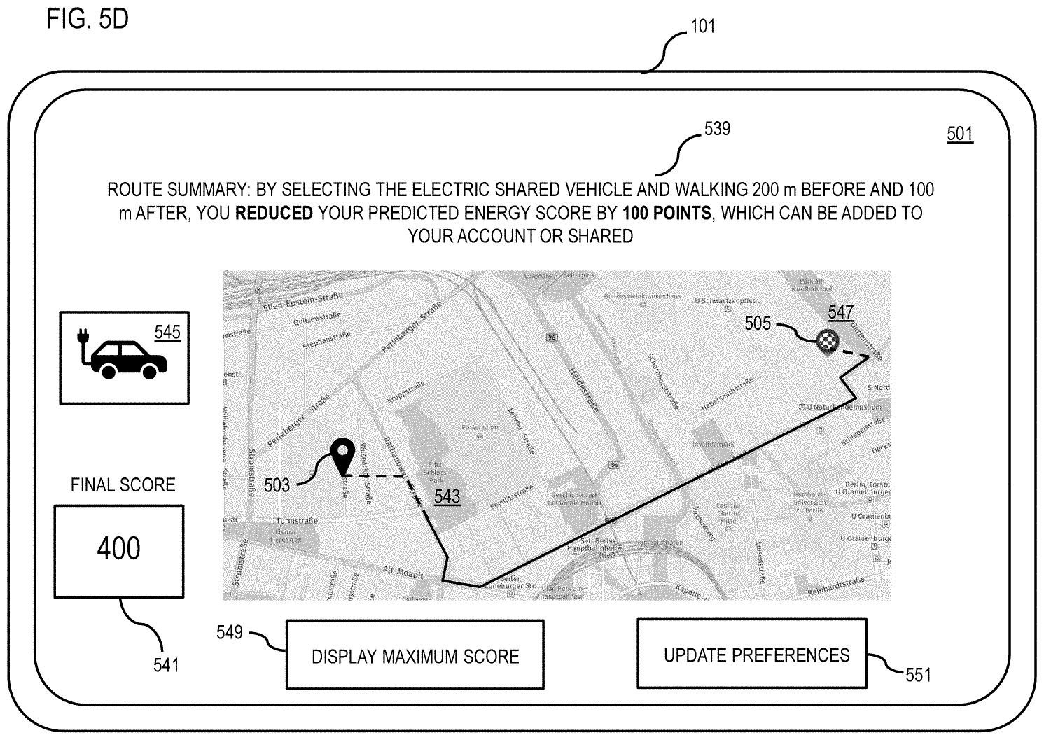

FIGS. 5A through 5D are diagrams of example user interfaces capable of providing a contextually relevant vehicle comparison for a given trip, according to example embodiment(s). Referring to FIG. 5A, in one embodiment, the system 100 generates a user interface (UI) 501 (e.g., a navigation application 107) for a UE 101 (e.g., a mobile device, a smartphone, a client terminal, etc.) that can enable a user to easily compare the various means or modes of transportation available to complete a given trip including the corresponding attributes and variables in a way that is contextually relevant and easily understood.

In one embodiment, the system 100 can determine that a user has made a trip request with contextual information via the UI 501. In one instance, the system 100 can generate the UI 501 such that it includes an input 507 (e.g., “origin/destination”) as well as an input 509 (e.g., “leave/arrive”) to enable a user to input a destination (e.g., destination 505) in terms of location (e.g., by name, latitude, longitude, etc.) and/or in terms of time (e.g., arrival time), respectively. In one instance, the system 100 generates the UI 501 such that a user can interact with the inputs 507 and 509 via one or more physical interactions (e.g., a touch, a tap, a gesture, typing, etc.), one or more voice commands (e.g., “destination 505 as soon as possible”), or a combination thereof. In this example, a user (e.g., a doctor) wants a route or route guidance between her origin 503 (e.g., a hospital) and the destination 505 (e.g., beach volleyball courts) after work Friday evening and wants to do so in an environmentally friendly manner but is tired after working all day/week and wants to save some energy for exercising at the destination 505. In this example, the system 100 can determine that the user interacts with the UI 501 by typing or saying, “volleyball courts 505 as soon as possible.”

In one embodiment, if the system 100 can access a user's calendar information or data (e.g., with the user's permission) and a POI database (e.g., the geographic database 109), the system 100 can automatically determine a relevant destination (e.g., beach volleyball courts 505) based on a user's location, schedule, etc. By way of example, the system 100 can detect a user's location (e.g., hospital 503) via a device sensor 111 (e.g., a GPS sensor), a vehicle sensor 115 (e.g., a GPS sensor), or a combination thereof. In one embodiment, the system 100 can determine a relevant destination based on the user's schedule, a user's mobility graph or historical mobility patterns, or a combination thereof (e.g., stored in or accessed via the geographic database 109). By way of example, the system 100 can determine that the user has traveled from the hospital 503 to the volleyball courts 505 every Friday night for the last two months and, therefore, is likely to do so this Friday night as well. As previously mentioned, in one embodiment, the system 100 can determine and/or recommend the most suitable vehicle (e.g., balancing energy efficiency and convenience) as a function of the vehicle 113 (e.g., gas mileage, pollution levels, etc.) as well as a function of how “good/efficient” the vehicle 113 is used for a given trip.

In one embodiment, based on the trip request, the system 100 can collect data from various sources (e.g., shared vehicles 113, shared vehicle or mobility providers, weather services 119, traffic providers 121, etc.) to determine an index/score for all available vehicles 113. In one instance, the system 100 can determine the number and location of vehicles 113 within a threshold proximity of the user (e.g., the hospital 503) or the destination 505 based on a device sensor 111, a vehicle 115, information or data stored in or accessed via the geographic database 109, a service provider 119, a content provider 121, or a combination thereof. In this example, the system 100 can determine that vehicles 113 corresponding to the icons 511-519 are within the threshold proximity of the user and that walking corresponding to the icon 521 are all possible options representing varying degrees of energy efficiency and convenience. Specifically, the icon 511 represents a private mode of transportation (e.g., the user's late model gas-powered vehicle 113); the icon 513 represent a public mode of transportation (e.g., a bus or a tram 113); the icons 515-519 represent various shared vehicle options (e.g., types of vehicles 113 from a pool or fleet of shared vehicles 113), and the icon 521 represents walking. With respect to the shared vehicle options, the icon 515 corresponds to an electric shared vehicle 113, the icon 517 represents a gas-powered shared vehicle 113 (e.g., a taxi), and the icon 519 represents a shared scooter 113.

In one instance, the system 100 can generate routes (e.g., routes 523, 525, and 527) corresponding to the various available means or modes of transportation (e.g., represented by icons 511-521). For example, route 523 corresponds to the user's own vehicle 511, the taxi 517, and the shared scooter 519; route 525 corresponds to the bus 513, and route 527 corresponds to walking 521. In addition, to multiple overlapping routes 523, the presentation of all this information can make it cognitively difficult for a user to effortlessly determine the most energy efficient means or mode of transportation to take to the destination 505 considering all the relevant variables and attributes (e.g., vehicle, trip, user preference, etc.). Accordingly, in one embodiment, the system 100 can generate the UI 501 such that it includes an input 529 (e.g., “show most suitable vehicle”) that enables the system 100 to provide a contextually relevant recommendation of the most suitable vehicle to reach the destination 505 according to the various embodiments described herein (e.g., balancing energy efficiency and convenience). In one instance, the system 100 can automatically determine when the amount of provided information reaches a certain threshold of readability (e.g., based on a screen size or a type of user activity) at which time, it can recommend the most suitable vehicle via the UI 501. By way of example, the most suitable vehicle 113 (e.g., most energy efficient vehicle 113) may include one or more different types of vehicles 113, walking, multimodal or intermodal routes, etc.

In one embodiment, the system 100 can recommend the most suitable vehicle 113 for the trip (e.g., hospital 503 to beach volleyball courts 505) given the context and constraints based on the determined index/scores for all available vehicles 113 (e.g., corresponding to icons 511-519). In one instance, the system 100 can recommend the most suitable vehicle 113 by presenting a ranking of all possible vehicle 113 options and their relative scores to support decision making. In one embodiment, the system 100 may only present the vehicles 113 that have a ranking corresponding to a certain threshold value (e.g., 1^{st} through 3^{rd}). In one instance, the system 100 can present the most suitable vehicles 113 relative to the user's own vehicle 113 (e.g., icon 511), as depicted in FIG. 5B. In another instance, if a user does not have a vehicle 113, the system 100 can prioritize one or more shared vehicles 113 (e.g., icons 515-519), public transportation vehicles 113 (e.g., icon 515), or other suitable means (e.g., walking 521), as depicted in FIG. 5C. In one embodiment, the system can generate the UI 501 such that it includes an input 531 (e.g., “calculate return”) to enable a user to see whether the system 100 recommends the same vehicle 113 for the trip to the destination (e.g., destination 505) as well as a return trip from the destination. By way of example, in this instance, the user may not return to hospital 503 after exercising at the beach volleyball courts 505 on a Friday night and, therefore, the system 100 will likely need to consider different contextual factors when determining the most suitable vehicle 113 for the return trip (e.g., home).

Referring to FIG. 5B, in one embodiment, the system 100 can present the most suitable vehicles 113 (e.g., corresponding to icons 515 and 517) relative to the user's own vehicle 113 (e.g., corresponding to icon 511) in a ranked order (e.g., ascending, descending, vertical, horizontal, etc.) via the UI 501 (e.g., a “vehicle scores” screen). In this example, the system 100 can present the possible vehicle 113 options and their relative scores to support decision making. For example, the system 100 can score the electric shared vehicle 113 (icon 515): 500, the user's own vehicle 113 (icon 511): 900, and the gas-powered shared vehicle 113 (e.g., a taxi or mobility operator vehicle) (icon 517): 900. In other words, the system 100 can determine that the electric shared vehicle 113 is the most suitable for the trip (e.g., balancing energy efficiency and convenience). In one embodiment, the system 100 can generate the score, for example, as a numeric value, a graphic representation (e.g., stars, a color, a transparency level, etc.), or a combination thereof. In one instance, the system 100 can generate the UI 501 such that a user can interact with the icons 511-521 (e.g., a touch or a tap) to learn more information about the corresponding vehicle 113, to switch or swap icons to view additional or alternative comparisons, or a combination thereof. The system 100 can also, in one embodiment, present the most suitable vehicles 113 in an audible form (e.g., using computer generated speech). For example, the system 100 can present the most suitable vehicles 113 audibly in situations where it may be unsafe to view or focus too long on the UI 501 (e.g., while driving through a busy intersection).

As mentioned, in this example, the system 100 computed the respective vehicle 113 scores using the user's own vehicle 113 (icon 511) as the default option. By way of example, the system 100 can determine that the user's late model gas-powered vehicle 113 generates relatively more pollution than the electric shared vehicle (icon 515) (e.g., 400 to 0), but approximately the same amount of pollution as the gas-powered vehicle 113 (icon 517) (e.g., 400 to 400). In addition, the system 100 can determine that the user's own vehicle 113 (icon 511) may have relatively higher operation costs than the electric shared vehicle (icon 515) (e.g., 300 to 200) or the taxi 113(icon 517) (e.g., 300 to 100) and between the two shared vehicles 113 (icons 515 and 517), the system 100 can determine that the “costs” associated with the private use of an electric shared vehicle 113 (icon 515) may be relatively greater than using a gas-powered shared vehicle such as a taxi or a mobility operator vehicle 113 (icon 517), at least from a user's perspective (e.g., 200 to 100). Further, the system 100 can determine that the convenience of the user's own vehicle 313 (icon 511) may be relatively greater than that of the electric shared vehicle 313 (icon 515) (e.g., based on the proximity of the electric shared vehicle 113 to the hospital 503 and/or a drop off location relative to the destination 505) (e.g., 200 to 300). In many cases, the system 100 can determine that the convenience of a gas-powered shared vehicle 113 (e.g., a taxi or a mobility operator vehicle) may be greater than the user's own vehicle 113 (e.g., not having to find parking at a destination, no ownership costs, etc.); however, in this instance, the user wants to travel on a Friday night after work, which is historically a time of low shared vehicle 113 availability and, therefore, long wait times. For example, the user may walk to the destination 505 in the same amount of time as it would take before a gas-powered shared vehicle 113 became available.

In one embodiment, the system 100 can compute the vehicle 113 score based on an evenly weighted addition of the all the contextually available information; however, in other instances, as previously described, the system 100 can independently weight various information and data corresponding to suitability or energy efficiency interests (e.g., weighting the pollution score more than the convenience score, or vice-versa). In one embodiment, the system 100 can generate the UI 501 such that it includes an input 533 to add/delete one or more factors as well as to customize the one or more factors considered by the system 100; an input 535 to increase or decrease the amount of weight attributed by the system 100 to one or more factors; and an input 537 to reset the system 100's calculation back to a default or factory setting. Like the inputs 507, 509, 529, and 531, the system 100 can also generate the inputs 533, 535, and 537 such that a user can interact with the respective inputs using one or more physical interactions, one or more voice commands, or a combination thereof. In one embodiment, the system 100 can generate the UI 501 such that a user can cause the system 100 to generate a respective route, reserve a respective vehicle 113, etc. via a physical gesture with an icon (e.g., icon 515), a voice command, etc. In one instance, the system 100 can automatically select or reserve the highest scored vehicle 113 or automatically select or reserve a vehicle 113 that meets or exceeds a certain threshold score (e.g., <300).

Referring to FIG. 5C, in one embodiment, if a user does not have her own vehicle 113 or the user's own vehicle 113 is not within a threshold proximity, the system 100 can present the most suitable available vehicles 113 (e.g., corresponding to icons 519, 513, and 517) in a ranked order (e.g., ascending, descending, vertical, horizontal, etc.) via the UI 501 (e.g., a “vehicle scores” screen) based on a prioritization of shared vehicles 113 (icons 519 and 517), public transportation vehicles 113 (icon 513), or other suitable means. Again, the system 100 can present the possible vehicle 113 options and their relative scores to support decision making. For example, the system 100 can score the shared scooter 113 (icon 519): 400, the bus 113 (icon 513): 600, and the gas-powered shared vehicle (e.g., a taxi or a mobility operator vehicle) (icon 517): 900. In other words, the system 100 can determine that the shared scooter (icon 519) is the most suitable for the trip (e.g., balancing efficiency and convenience).

By way of example, the system 100 can determine that the gas-powered shared vehicle 113 (e.g., a taxi) (icon 517) generates relatively more pollution compared to the shared scooter 113 (icon 519) (e.g., 300 to 100) and slightly more pollution than the bus 113 (icon 513) (e.g., 300 to 200). For example, the bus 113 (icon 513) may generate more pollution as a function of the vehicle 113, but less overall pollution based on the number of users that can simultaneous ride on the bus 113 rather than use individual vehicles 113 (e.g., icon 517). In addition, the system 100 can determine that the bus 113 has the lowest operation costs (e.g., ticket or fare price) for a user (e.g., a passenger) relative to the shared scooter 113 (icon 519) (e.g., 100 to 200) and to the gas-powered shared vehicle 113 (icon 517) (e.g., 100 to 200). In the instance where the user is an owner or operator of a fleet of shared or public vehicles 113, the system 100 can determine that the operation costs of the bus 113 are much higher relative to a shared scooter 113 (icon 519) and even a gas-powered shared vehicle 113 (icon 517). Further, the system 100 can determine that the convenience of the shared scooter 113 (icon 519) is relative higher than the bus 113 (icon 513) (e.g., 100 to 300) and the gas-powered vehicle 113 (icon 517) (e.g., 100 to 400). However, the system 100's computation could depend on such contextual factors as the proximity of an available shared scooter 113 (icon 519) (e.g., determined based on a vehicle sensor 115), weather conditions (e.g., based on a weather report from a service 119), etc. In addition, as previously mentioned, whereas the system 100 may normally compute a gas-powered shared vehicle 113 (icon 517) with a higher convenience score compared to a bus 113 (icon 513) (e.g., limited to a static route, times, hubs, etc.), in this instance, the user wants to travel to the destination 505 on a Friday night after work, which is historically a time of low shared vehicle 113 availability and, therefore, long wait times.

Referring to FIG. 5D, in one embodiment, during and/or after the completion of a trip, the system 100 can generate a summary 539 or a measure 541 of how efficiently the user traveled to the destination (e.g., a “final score”) based on a function of the selected vehicle 113 and how “good/efficient” the vehicle 113 was used for that trip. By way of example, the system 100 can generate the summary 539 or measure 541 during a trip (e.g., in real-time, periodically, at any frequency requested by a user, etc.) in case a user wants to modify her score along the way (e.g., walking further before or after using a vehicle 113). For example, a more efficient vehicle 113 that was previously too inconvenient or unavailable may become available or get dropped off along the user's route. In this example, a user decided to use the highest ranked or recommended vehicle 113 from FIG. 5B (e.g., an electric shared vehicle 113) to complete the trip to the destination 505; however, rather than taking the closest electric shared vehicle 113 relative to the hospital 503 (icon 515), which the system 100 used to compute the score of 500, the user decided to walk 200 m to the nearby park 543 to pick up another electric shared vehicle 113 (icon 545). In addition, rather than parking or dropping off the vehicle 113 at the destination 505, which the system 100 used to compute the score of 500, the user dropped off the vehicle at the park 539 and walked 100 m to make it more convenient for a subsequent user of the vehicle 113. As a result, the system 100 can compute that the user reduced the predicted score by 100 points resulting in a final score of 400 rather than the predicted score of 500. In one embodiment, it is contemplated that the user may use the energy savings (e.g., 100 points) in connection with a past, present, or future trip (e.g., a reduced rate, shorter wait time, better vehicle 113 choice, etc.) or the user may share the savings with a friend, the community, etc. in an effort to promote greater energy efficiency.

In certain instances, the additional steps taken by a user to reduce her energy efficiency score relative to a given trip may be all that the user could have achieved. However, in other instances, due to real-time or recent changes in contextually available information (e.g., a recently available shared vehicle 113, a rainstorm stopping, new parking rules, an ongoing street fair, etc.), the user may have been able to further maximize her final energy efficiency score 541. In one embodiment, the system 100 generates the UI 501 such that it includes an input 549 (e.g., “display maximum score”) to see whether the user achieved a maximum energy efficiency and if not, what steps could have been taken to achieve that result. In one embodiment, it is contemplated that a user (e.g., a software developer) may use the input 549 to flag a score or recommended vehicle 113 for further evaluation and/or verification (e.g., if there is a great disparity between the highest predicted score and the maximum score upon completion). In one embodiment, the system 100 can generate the UI 501 such that it includes an input 551 (“update preferences”) to enable a user to update the system 100 with respect to her selections and/or preferences (e.g., stored in or accessible via the geographic database 109) for later use or reference. In one instance, the system 100 can automatically keep or save the user's selections for later processing or system updates (e.g., using the machine learning system 123).

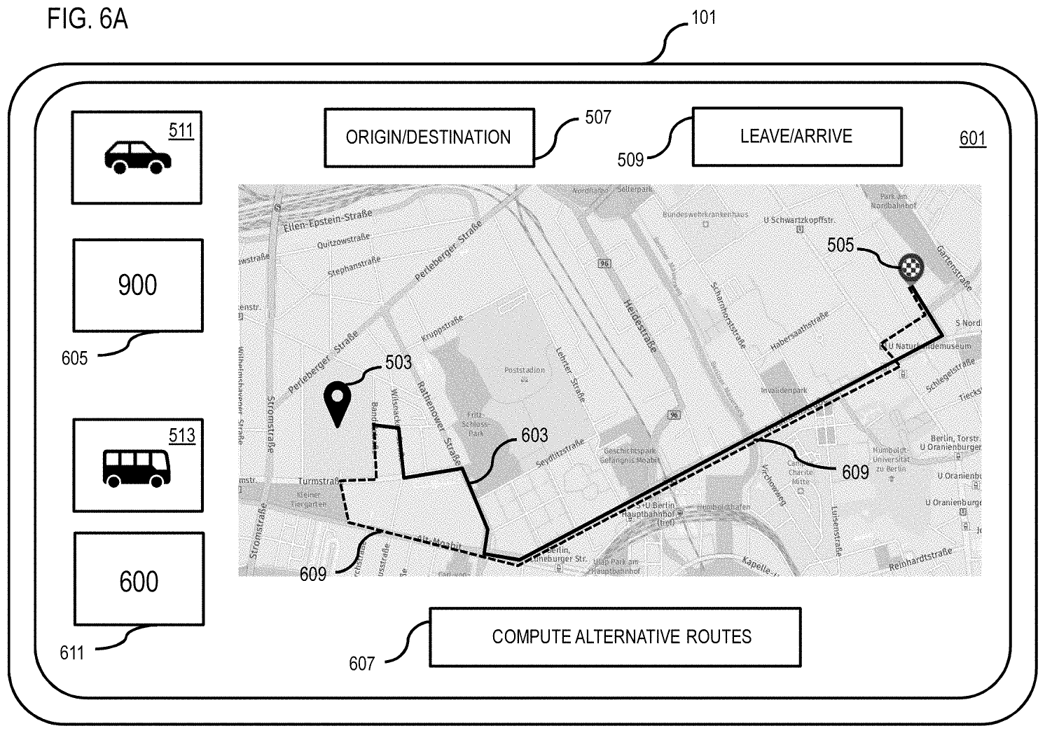

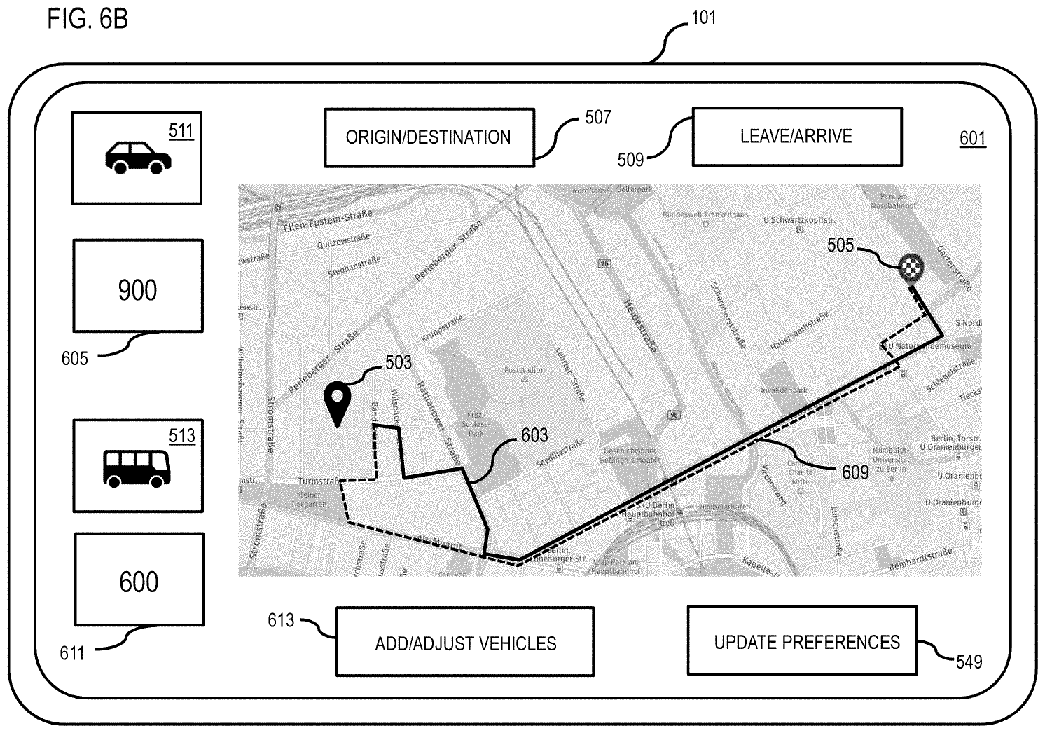

FIGS. 6A and 6B are diagrams of example user interfaces capable of providing a contextually relevant vehicle comparison for a given trip, according to example embodiment(s). Referring to FIG. 6A, in one embodiment, the system 100 generates a UI 601 (e.g., a navigation application 107, etc.) for a UE 101 (e.g., a mobile device, a smartphone, a client terminal, etc.) with the same or similar functionality as the UI 501 described above with respect to the FIGS. 5A through 5D. In this instance, the system 100 can generate the UI 601 so that a user can compare alternative routes using nearby shared vehicles 113 and other alternative modes relative to a route generated based on using the user's own vehicle 113 (icon 511). In one embodiment, the system 100 can also generate the UI 501 such that it can also provide this same or similar comparison.

Following the use case example of FIGS. 5A-5D, in one embodiment, the system 100 can determine that a user entered a destination (e.g., beach volleyball courts 505) via the UI 601. In this instance, the system 100 can generate the UI 601 such that it includes the input 507 (e.g., “origin/destination”) and the input 509 (e.g., “leave/arrive”) of FIG. 5A to enable a user (e.g., the doctor) to enter the destination 505 using one or more physical gestures, a voice command, or a combination thereof. In one embodiment, the system 100 can compute a route (e.g., route 603) based on the user's own vehicle 113 (icon 511) and the corresponding index/score 605 (e.g., 900 as described with respect to FIG. 5B) for the trip according to the various embodiments described herein and then presents the route 603 and the score 605 to the user via the UI 601.

In one embodiment, the system 100 can generate the UI 601 such that it includes an input 607 (e.g., “compute alternative routes”) to enable a user to use the UI 601 to compute one or more alternative routes using one or more nearby shared vehicles 113 (e.g., corresponding to icons 515-519) and other alternative modes (e.g., corresponding to icons 513 and 521) and their energy cost 609. In one instance, like inputs 507 and 509, the system 100 can also generate the input 607 so that a user can initiate the comparison process using one or more physical gestures, a voice command, or a combination thereof. The system 100 can determine, for example, one or more shared vehicles 113 are within a threshold proximity of the user based on respective vehicle sensors 115 (e.g., GPS sensors). In this example, the system 100 can compute an alternative route (e.g., route 609) based on the determination of a nearby bus 313 (icon 513) (e.g., based on a vehicle sensor 115) and the corresponding index/score 611 (e.g., 600 as described with respect to FIG. 5B) and then present the route 609 and the score 611 to the user via the UI 601. As such, a user can get a comparative view of all options for a given trip to support user decision making.

Referring to FIG. 6B, in one embodiment, the system 100 can generate the UI 601 such that it includes an input 613 (e.g., “add/adjust vehicles”) that can enable a user to add or adjust (e.g., increase or decrease) the threshold of proximity by which the system 100 considers a vehicle 113 “nearby.” In one instance, the system 100 will only allow as many vehicles 113 to be displayed via the UI 601 such that the comparison maintains a threshold level of readability (e.g., based on the screen size or a user's current activity). For example, the system 100 may display more vehicles while a user is stationary (e.g., based on a device sensor 111), but a minimum number of vehicles while a user is walking or driving (e.g., based on a device sensor 111). In addition, in one embodiment, the system 100 can generate the UI 601 such that it includes the input 547 (“update preferences”) to enable a user to update her selections and/or preferences (e.g., stored in or accessible via the geographic database 109) for use in connection with subsequent trips.

Returning to FIG. 1, in one embodiment, the UEs 101 (e.g., a mobile device, a smartphone, a client terminal, etc.) may be associated with a user (e.g., a driver, a passenger, a shared vehicle service provider, a software developer, etc.) or with a vehicle 113 (e.g., an embedded navigation system). By way of example, the UEs 101 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles 113 or any combination thereof, including the accessories and peripherals of these devices, or any combination thereof. It is also contemplated that a UE 101 can support any type of interface to the user (such as “wearable” circuitry, etc.). In one embodiment, the vehicles 113 may have cellular or wireless fidelity (Wi-Fi) connection either through the inbuilt communication equipment or from a UE 101 associated with the vehicles 113. Also, the UEs 101 may be configured to access the communication network 105 by way of any known or still developing communication protocols. In one embodiment, the UEs 101 may include the mobility platform 103 to provide a contextually relevant vehicle comparison for a given trip.

In one embodiment, the UEs 101 include applications 107 (e.g., mapping applications, navigation applications, shared vehicle booking or reservation applications, public transportation timetable applications, etc.) and device sensors 111 (e.g., GPS sensors, a front facing camera, a rear facing camera, multi-axial accelerometers, height sensors, tilt sensors, moisture sensors, pressure sensors, wireless network sensors, etc.). In one embodiment, the GPS sensors 111 can enable the UEs 101 to obtain geographic coordinates from satellites 125 for determining current or live location and time. Further, a user location within an area may be determined by a triangulation system such as A-GPS, Cell of Origin, or other location extrapolation technologies when cellular or network signals are available.

In one embodiment, the mobility platform 103 performs the process for providing a contextually relevant vehicle comparison for a given trip as discussed with respect to the various embodiments described herein. In one embodiment, the mobility platform 103 can be a standalone server or a component of another device with connectivity to the communication network 105. For example, the component can be part of an edge computing network where remote computing devices (not shown) are installed along or within proximity of an intended destination (e.g., a city center).

In one embodiment, the machine learning system 123 of the mobility platform 103 includes a neural network or other machine learning system to compute an index/score value per candidate vehicle 113 for a given trip or route based on all available contextually relevant information or data. In one instance, the machine learning system 123 can select and/or update the respective weights or weighting schemes related to the contextual data, the respective convenience factors, the balancing of the respective energy-efficiency scores and the respective convenience factors, or a combination thereof based on the monitoring during or after a completion of a trip. For example, when the inputs are locations and attributes of shared vehicles 113, locations and attributes of a user's own vehicle(s) 113, number of passengers, traffic data, mobility graph/user mobility patterns, operation costs, parking restrictions, etc., the output can be a measure of efficient car usage that is not only a function of the vehicles 113 but also how “good/efficient” a vehicle 113 is used for a given trip. In one embodiment, the machine learning system 123 can iteratively improve the speed and accuracy by which the system 100 ranks and/or compares available vehicles 113 based on all contextually available information as well the likelihood that a user will ultimately select the recommended vehicle 113 for a trip. In one embodiment, the neural network of the machine learning system 123 is a traditional convolutional neural network which consists of multiple layers of collections of one or more neurons (which are configured to process a portion of an input data). In one embodiment, the machine learning system 123 also has connectivity or access over the communication network 105 to the geographic database 109 that can store labeled or marked features (e.g., applicable factors and attributes, contextually relevant information related to the vehicles 113, a trip, user preferences, respective weights or weighting schemes, user metrics, saved balances of the respective energy efficiency scores and the respective convenience factors, etc.).

In one embodiment, the mobility platform 103 has connectivity over the communications network 105 to the services platform 117 (e.g., an OEM platform) that provides the services 119 (e.g., navigation/routing services). By way of example, the services 119 may also be other third-party services and include mapping services, navigation services, shared vehicle or mobility services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 117 uses the output (e.g. vehicle ranking and/or recommendation data) of the mobility platform 103 to provide services such as navigation, mapping, shared vehicle or mobility services (e.g., automated vehicle services), other location-based services, etc.

In one embodiment, the content providers 121 may provide content or data (e.g., respective attributes of all vehicles 113 (e.g., fuel/EV charging, number of seats, transmission type, trunk size, etc.), road attributes (e.g., width, size, directionality, etc.), traffic data, including road attributes, terrain data/topology, historical travel data for a user, health related information, weather, population models, traffic data, on street parking around trip destination(s), weather, parking restrictions, on street parking availability from real-time parking street management systems, known locations for emergency infrastructure (e.g., fire hydrants), nearby event data (e.g., street fairs, festivals, etc.), cost of street parking, etc. to the UEs 101, the mobility platform 103, the applications 107, the geographic database 109, the vehicles 113, the services platform 117, and the services 119. The content provided may be any type of content, such as map content, text-based content, audio content, video content, image content, etc. In one embodiment, the content providers 121 may provide content regarding the movement of a UE 101, a vehicle 113, or a combination thereof on a digital map or link as well as content that may aid in localizing a user path or trajectory on a digital map or link (e.g., to assist with determining a vehicle 113's future location). In one embodiment, the content providers 121 may also store content associated with the mobility platform 103, the geographic database 109, the vehicles 113, the services platform 117, and/or the services 119. In another embodiment, the content providers 121 may manage access to a central repository of data, and offer a consistent, standard interface to data, such as a repository of the geographic database 109.

In one embodiment, a UE 101 and/or a vehicle 113 may be part of a probe-based system for collecting probe data for computing routes for all available transport modes and/or user historical routes. In one embodiment, each UE 101 and/or vehicle 113 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 113 may include vehicle sensors 115 for reporting measuring and/or reporting attributes. The attributes can also be any attribute normally collected by an on-board diagnostic (OBD) system of the vehicle 113, and available through an interface to the OBD system (e.g., OBD II interface or other similar interface).

In one embodiment, the probe points can be reported from the UE 101 and/or the vehicle 113 in real-time, in batches, continuously, or at any other frequency requested by the system 100 over, for instance, the communication network 105 for processing by the mobility platform 103. The probe points also can be map matched to specific road links stored in the geographic database 109. In one embodiment, the system 100 (e.g., via the mobility platform 103) generates user or vehicle paths or trajectories from the observed and expected frequency of probe points for an individual probe so that the probe traces represent routes for all available transport modes, user historical routes, or a combination thereof through a given area.

In one embodiment, as previously stated, the vehicles 113 are configured with various sensors (e.g., vehicle sensors 115) for generating or collecting probe data, sensor data, related geographic/map data (e.g., routing data), etc. In one embodiment, the sensed data represents sensor data associated with a geographic location or coordinates at which the sensor data was collected (e.g., a latitude and longitude pair). In one embodiment, the probe data (e.g., stored in or accessible via the geographic database 109) includes location probes collected by one or more vehicle sensors 115. By way of example, the vehicle sensors 115 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 113, switch sensors for determining whether one or more vehicle switches are engaged, and the like. Though depicted as automobiles, it is contemplated the vehicles 113 can be any type of private, public, or shared manned or unmanned vehicle (e.g., cars, trucks, buses, vans, motorcycles, scooters, bicycles, drones, etc.) that can enable a user to complete a given trip through one or more segments of a road network.

Other examples of sensors 115 of a vehicle 113 may include light sensors, orientation sensors augmented with height sensors and acceleration sensor (e.g., an accelerometer can measure acceleration and can be used to determine orientation of the vehicle), tilt sensors to detect the degree of incline or decline of a vehicle 113 along a path of travel, moisture sensors, pressure sensors, etc. In a further example embodiment, vehicle sensors 115 about the perimeter of a vehicle 113 may detect the relative distance of the vehicle 113 from a physical divider, a lane line of a link or roadway, the presence of other vehicles, pedestrians, traffic lights, potholes and any other objects, or a combination thereof. In one scenario, the vehicle sensors 115 may detect contextually available information such as weather data, traffic information, or a combination thereof. In one embodiment, a vehicle 113 may include GPS or other satellite-based receivers 115 to obtain geographic coordinates from satellites 125 for determining current location and time. Further, the location can be determined by visual odometry, triangulation systems such as A-GPS, Cell of Origin, or other location extrapolation technologies.

In one embodiment, the UEs 101 may also be configured with various sensors (e.g., device sensors 111) for acquiring and/or generating probe data and/or sensor data associated with a user, a vehicle 113 (e.g., a driver or a passenger), other vehicles, conditions regarding the driving environment or roadway, etc. For example, such sensors 111 may be used as GPS receivers for interacting with the one or more satellites 125 to determine a user location (origin) as well as to track the current speed, position and location of a user or a vehicle 113 travelling along a link or on a road segment. In addition, the sensors 111 may gather tilt data (e.g., a degree of incline or decline of a vehicle 113 during travel), motion data, light data, sound data, image data, weather data, temporal data, and other data associated with the vehicles 113 and/or UEs 101. Still further, the sensors 111 may detect local or transient network and/or wireless signals, such as those transmitted by nearby devices during navigation along a roadway (Li-Fi, near field communication (NFC)) etc.

It is noted therefore that the above described data may be transmitted via the communication network 105 as probe data (e.g., GPS probe data) according to any known wireless communication protocols. For example, each UE 101, application 107, user, and/or vehicle 113 may be assigned a unique probe identifier (probe ID) for use in reporting or transmitting said probe data collected by the vehicles 113 and/or UEs 101. In one embodiment, each vehicle 113 and/or UE 101 is configured to report probe data as probe points, which are individual data records collected at a point in time that records telemetry data.

In one embodiment, the mobility platform 103 retrieves aggregated probe points gathered and/or generated by the device sensors 111 and/or vehicle sensors 115 resulting from the travel of the UEs 101 and/or vehicles 113 on a road segment of a road network of a digital map. In one instance, the geographic database 109 stores a plurality of probe points and/or trajectories generated by different UEs 101, device sensors 111, applications 107, vehicles 113, vehicle sensors 115, etc. over a period while traveling in a large monitored area. A time sequence of probe points specifies a trajectory—i.e., a path traversed by a UE 101, an application 107, vehicle 113, etc. over the period.

In one embodiment, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the mobility platform 103 may be a platform with multiple interconnected components. The mobility platform 103 may include multiple servers, intelligent networking devices, computing devices, components, and corresponding software for providing parametric representations of lane lines. In addition, it is noted that the mobility platform 103 may be a separate entity of the system 100, a part of the services platform 117, a part of the one or more services 119, or included within a vehicle 113 (e.g., an embedded navigation system).

In one embodiment, the geographic database 109 can store information regarding locations and attributes of shared vehicles 113, locations and attributes of a user's own vehicle(s) 113, road attributes (e.g., width, size, directionality, etc.), traffic data, on street parking around trip destination(s), weather, parking restrictions, on street parking availability from real-time parking street management systems, known locations for emergency infrastructure (e.g., fire hydrants), nearby event data (e.g., street fairs, festivals, etc.), cost of street parking, etc. In one instance, the geographic database 109 can store vehicle ranking factors and attributes, corresponding information and data, weights and/or weighting schemes, labeled and/or marked features and attributes, user account information, user preferences, vehicle's and user's metrics upon completion of a trip, POI data (e.g., location data), etc. The information may be any of multiple types of information that can provide means for providing a contextually relevant vehicle comparison for a given trip. In another embodiment, the geographic database 109 may be in a cloud and/or in a UE 101, a vehicle 113, or a combination thereof.

By way of example, the UEs 101, mobility platform 103, applications 107, device sensors 111, vehicles 113, vehicle sensors 115, services platform 117, services 119, content providers 121, and/or satellites 125 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

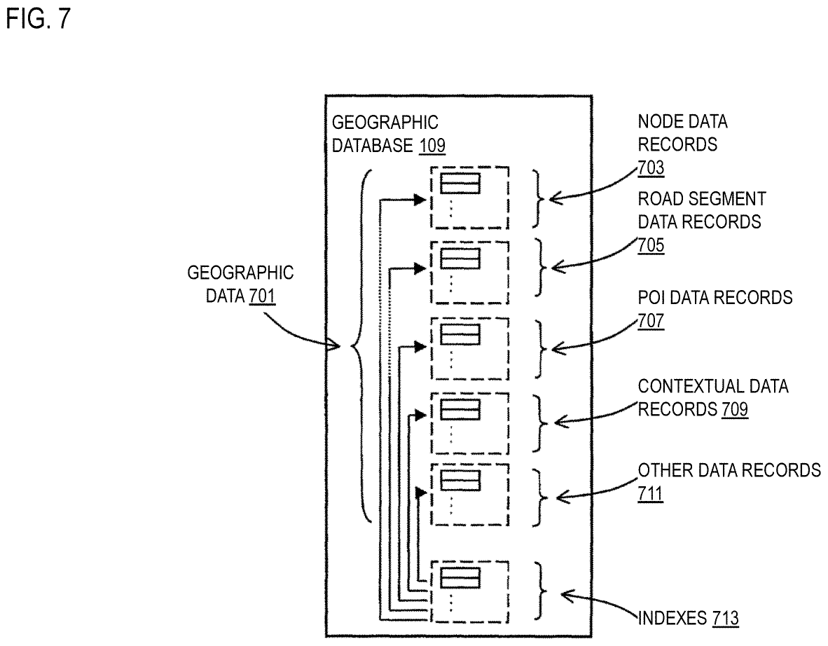

FIG. 7 is a diagram of a geographic database, according to example embodiment(s). In one embodiment, the geographic database 109 includes geographic data 701 used for (or configured to be compiled to be used for) mapping and/or navigation-related services. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more-line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node. Also, there are no duplicated shape points, nodes, or links. Two links that connect each other have a common node. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 109 includes node data records 703, road segment or link data records 705, POI data records 707, contextual data records 709, other records 711, and indexes 713, for example. More, fewer, or different data records can be provided. In one embodiment, additional data records (not shown) can include cartographic (“cartel”) data records, routing data, and maneuver data. In one embodiment, the indexes 713 may improve the speed of data retrieval operations in the geographic database 109. In one embodiment, the indexes 713 may be used to quickly locate data without having to search every row in the geographic database 109 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or route comparison for providing a contextually relevant vehicle comparison for a given trip. The node data records 703 are end points corresponding to the respective links or segments of the road segment data records 705. The road link data records 705 and the node data records 703 represent a road network, such as used by vehicles 113, cars, and/or other entities. Alternatively, the geographic database 109 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 707. The geographic database 109 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a portion of a city).

In one embodiment, the geographic database 109 includes contextual data records 709 (e.g., all contextually available information or data) related to vehicle 113 ranking factors and attributes, vehicle 113 prices and/or operation costs, shared vehicle 113 coverage areas, user familiarity with a vehicle 113, vehicle 113 types, etc., mobility graph/user mobility patterns, road attributes, traffic data, parking conditions and/or restrictions, weights or weighting schemes, balances between energy related factors and user preference parameters, labeled and/or marked features and attributes, user account information, user preferences, user account data, etc., and/or any other related data. In one embodiment, the contextual data records 709 can be associated with one or more of the node data records 703, road segment or link records 705, and/or POI data records 707; or portions thereof (e.g., smaller or different segments than indicated in the road segment records 705) to provide a contextually relevant vehicle comparison for a given trip.

In one embodiment, the geographic database 109 can be maintained by the services platform 117 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle along roads throughout the geographic region to observe features (e.g., road closures or other traffic incidents, etc.) and/or record information about them, for example. Also, remote sensing, such as aerial or satellite photography, can be used.

In one embodiment, the geographic database 109 include high resolution or high definition (HD) mapping data that provide centimeter-level or better accuracy of map features. For example, the geographic database 109 can be based on Light Detection and Ranging (LiDAR) or equivalent technology to collect billions of 3D points and model road surfaces and other map features down to the number lanes and their widths. In one embodiment, the HD mapping data capture and store details such as the slope and curvature of the road, lane markings, roadside objects such as signposts, including what the signage denotes. By way of example, the HD mapping data enable highly automated vehicles to precisely localize themselves on the road, and to determine road attributes (e.g., learned speed limit values) to at high accuracy levels.

In one embodiment, the geographic database 109 is stored as a hierarchical or multi-level tile-based projection or structure. More specifically, in one embodiment, the geographic database 109 may be defined according to a normalized Mercator projection. Other projections may be used. By way of example, the map tile grid of a Mercator or similar projection is a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom or resolution level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grid 10. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one-dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid to maintain a constant length for the one-dimensional array of the quadkey. In another example, the length of the one-dimensional array of the quadkey may indicate the corresponding level within the map tile grid 10. In one embodiment, the quadkey is an example of the hash or encoding scheme of the respective geographical coordinates of a geographical data point that can be used to identify a tile in which the geographical data point is located.

The geographic database 109 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, a device sensor 111, a vehicle 113, and/or a vehicle sensor 115. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a contextually relevant vehicle comparison for a given trip may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

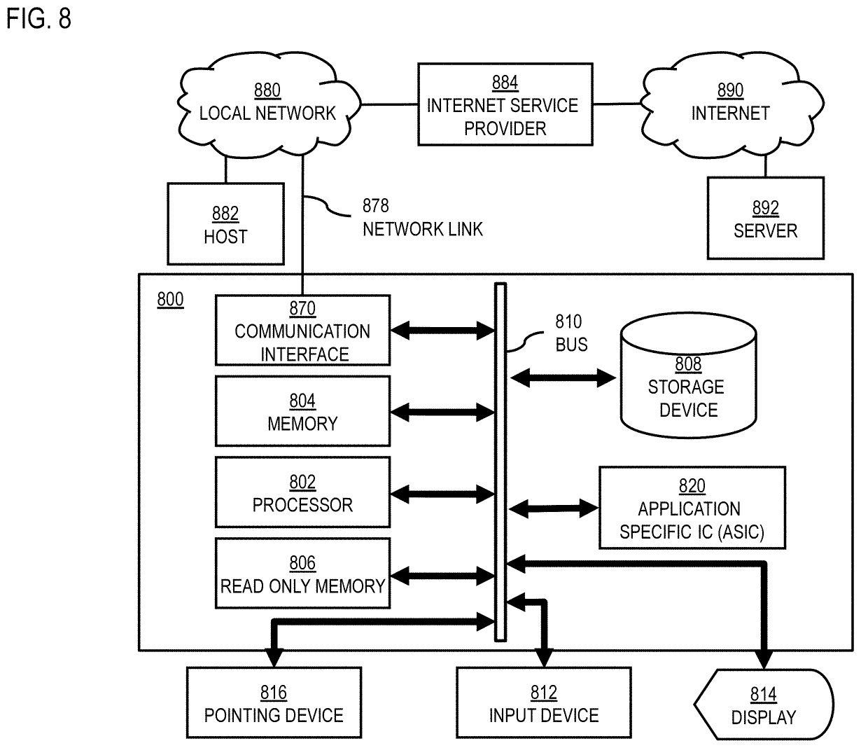

FIG. 8 illustrates a computer system 800 upon which example embodiment(s) of the invention may be implemented. Computer system 800 is programmed (e.g., via computer program code or instructions) to provide a contextually relevant vehicle comparison for a given trip as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to providing a contextually relevant vehicle comparison for a given trip. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random-access memory (RANI) or other dynamic storage device, stores information including processor instructions for providing a contextually relevant vehicle comparison for a given trip. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing a contextually relevant vehicle comparison for a given trip, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing a contextually relevant vehicle comparison for a given trip.

The term computer-readable medium is used herein to refer to any medium that participates in providing information to processor 802, including instructions for execution. Such a medium may take many forms, including, but not limited to, non-volatile media, volatile media, and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which example embodiment(s) of the invention may be implemented. Chip set 900 is programmed to provide a contextually relevant vehicle comparison for a given trip as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively, or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide a contextually relevant vehicle comparison for a given trip. The memory 905 also stores the data associated with or generated by the execution of the inventive steps.

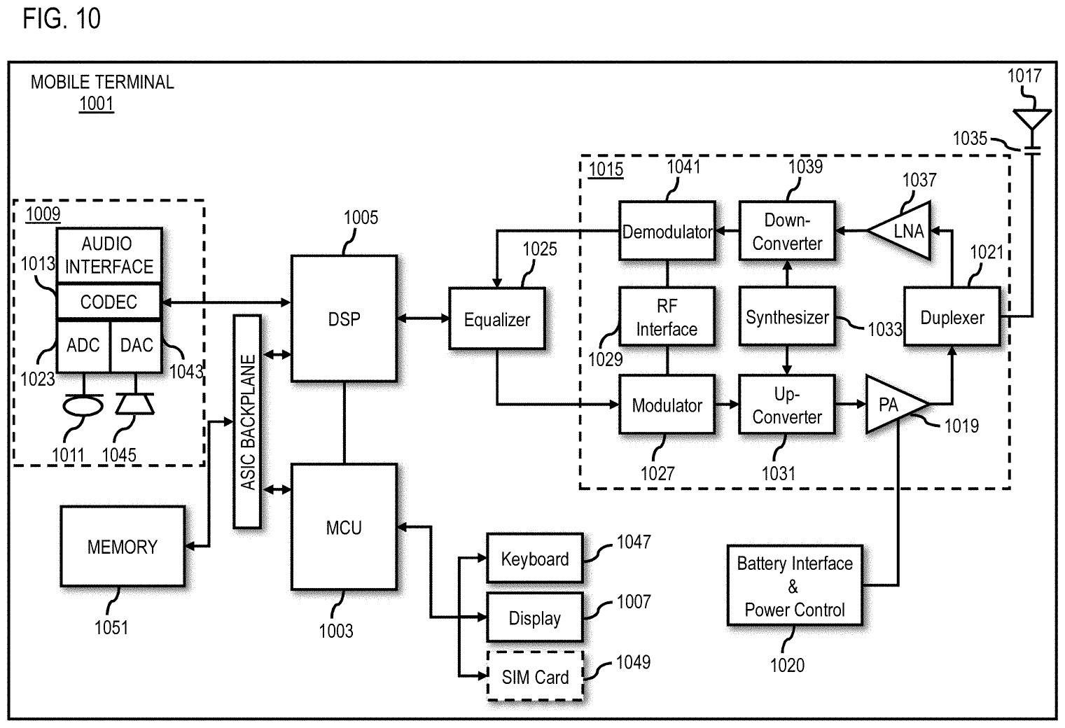

FIG. 10 is a diagram of exemplary components of a mobile terminal 1001 (e.g., a UE 101, a vehicle 113, or a component thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to provide a contextually relevant vehicle comparison for a given trip. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining contextual data associated with a trip request, a plurality of candidate vehicles available to complete the trip request, a plurality of candidate modes of vehicle operation available to complete the trip request, or a combination thereof;
processing the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request;
selecting a recommended vehicle, a recommended mode of vehicle operation, or a combination thereof based on the respective energy-efficiency scores; and
providing data for presenting the recommended vehicle, the recommended mode of vehicle operation, or a combination thereof.

2. The method of claim 1, further comprising:
processing the contextual data to calculate respective convenience factors for the plurality of candidate vehicles, the plurality of candidate modes of vehicle operation, or a combination thereof,
wherein each of the respective convenience factors respectively represent a predicted accessibility, a predicted familiarity, or a combination thereof; and
wherein the recommended vehicle, the recommended mode of vehicle operation, or a combination thereof is selected further based on the respective convenience factors.

3. The method of claim 2, wherein the recommended vehicle, the recommended mode of vehicle operation, or a combination thereof is selected further based on a balancing of the respective energy-efficiency scores and the respective convenience factors.

4. The method of claim 2, further comprising:
monitoring the contextual data, the respective convenience factors, or a combination thereof during or after a completion of the trip request; and
updating the respective energy-efficient scores based on the monitoring.

5. The method of claim 1, wherein the data for presenting the recommended vehicle, the recommended mode of vehicle operation, or a combination thereof is presented in a user interface that provides a comparative view of the recommended vehicle, the recommended mode of vehicle operation, the plurality of candidate vehicles, the plurality of candidate modes of vehicle operation, or a combination thereof.

6. The method of claim 5, wherein the user interface is a component of a ride-sharing service; and wherein the recommended vehicle is selected from the plurality of candidate vehicles, the plurality of candidate modes of vehicle operation, or a combination thereof that is part of a vehicle fleet of the ride-sharing service.

7. The method of claim 5, wherein the comparative view includes a representation of the respective energy-efficiency scores of the recommended vehicle, the recommended mode of vehicle operation, the plurality of candidate vehicles, the plurality of candidate modes of vehicle operation, or a combination thereof.

8. The method of claim 5, wherein the user interface provides a user interface element for specifying a target energy-efficiency score, and wherein the target energy-efficiency score is used to select, sort, filter, or a combination thereof the recommended vehicle, the recommended mode of vehicle operation, the plurality of candidate vehicles, the plurality of candidate modes of vehicle operation, or a combination thereof.

9. The method of claim 1, further comprising:
initiating an adjustment, an incentive, a penalty, or a combination thereof based on determining that a user has selected the recommended vehicle, a vehicle other than the recommended vehicle, the recommended mode of vehicle operation, or a mode of vehicle operation other than the recommended mode of vehicle operation, or a combination thereof.

10. The method of claim 9, wherein the adjustment, the incentive, the penalty, or a combination thereof is based on a difference between the respective energy-efficient scores of the selected vehicle and the recommended vehicle, the selected mode of vehicle operation and the recommended mode of vehicle operation, or a combination thereof.

11. The method of claim 1, wherein the trip request includes a trip to a destination and a return trip from the destination, and wherein the recommended vehicle, the recommended mode of vehicle operation, or a combination thereof is selected separately for the trip to the destination and the return trip from the destination.

12. The method of claim 1, wherein the plurality of candidate vehicles includes one or more user vehicles, one or more shared vehicles, one or more public transportation vehicles, or a combination thereof.

13. The method of claim 1, wherein the contextual data includes at least one of:
attribute data of the plurality of candidate vehicles, the plurality of candidate modes of vehicle operation, or a combination thereof;
a number people associated with the trip request;
a trip length;
a distance to the plurality of candidate vehicles;
pricing data for the plurality of candidate vehicles, the plurality of candidate modes of vehicle operation, or a combination thereof;
operational areas for shared vehicles of the plurality of candidate vehicles;
historical user experience data with the plurality of candidate vehicles, the plurality of candidate modes of vehicle operation, or a combination thereof;
weather data;
traffic data;
parking data;
nearby event data; or
road attribute data.

14. An apparatus comprising:
at least one processor; and
at least one memory including computer program code for one or more programs, the at least one memory and the computer program code configured to, with the at least one processor, cause the apparatus to perform at least the following operations:
determine contextual data associated with a trip request, a plurality of candidate vehicles available to complete the trip request, a plurality of candidate modes of vehicle operation available to complete the trip request, or a combination thereof;
process the contextual data to calculate respective energy-efficiency scores for the plurality of candidate vehicles, the plurality of candidate modes of vehicle operation, or a combination thereof, wherein each of the respective energy-efficiency scores respectively indicate a predicted energy efficiency to complete the trip request;
select a recommended vehicle, a recommended mode of vehicle operation, or a combination thereof based on the respective energy-efficiency scores; and
provide data for presenting the recommended vehicle, the recommended mode of vehicle operation, or a combination thereof.

15. The apparatus of claim 14, wherein the apparatus is further caused to:
process the contextual data to calculate respective convenience factors for the plurality of candidate vehicles, the plurality of candidate modes of vehicle operation, or a combination thereof,
wherein each of the respective convenience factors respectively represent a predicted accessibility, a predicted familiarity, or a combination thereof; and
wherein the recommended vehicle, the recommended mode of vehicle operation, or a combination thereof is selected further based on the respective convenience factors.

16. The apparatus of claim 15, wherein the recommended vehicle, the recommended mode of vehicle operation, or a combination thereof is selected further based on a balancing of the respective energy-efficiency scores and the respective convenience factors.

17. The apparatus of claim 15, wherein the apparatus is further caused to:
monitor the contextual data, the respective convenience factors, or a combination thereof during or after a completion of the trip request; and
update the respective energy-efficient scores based on the monitoring.

18. A non-transitory computer-readable storage medium having stored thereon one or more program instructions which, when executed by one or more processors, cause an apparatus to at least perform the following operations:
determining contextual data associated with a trip request, a plurality of candidate vehicles available to complete the trip request, a plurality of candidate modes of vehicle operation available to complete the trip request, or a combination thereof;
processing the contextual data to calculate respective energy-efficiency scores, respective convenience factors, or a combination thereof for the plurality of candidate vehicles, the plurality of candidate modes of vehicle operation, or a combination thereof;
selecting a recommended vehicle, a recommended mode of vehicle operation, or a combination thereof based on a balancing of the respective energy-efficiency scores and the respective convenience factors; and
providing data for presenting the recommended vehicle, the recommended mode of vehicle operation, or a combination thereof.

19. The non-transitory computer-readable storage medium of claim 18, wherein each of the respective energy-efficiency scores respectively indicate a predicted energy efficiency to complete the trip request, and wherein each of the respective convenience factors respectively represent a predicted accessibility, a predicted familiarity, or a combination thereof.

20. The non-transitory computer-readable storage medium of claim 18, wherein the apparatus is further caused to perform:
monitoring the contextual data, the respective convenience factors, or a combination thereof during or after a completion of the trip request; and
updating the respective energy-efficient scores based on the monitoring.
